(19) United States
(12) Patent Application Publication
(10) Pub. No.: US 2024/0236776 A1
(43) Pub. Date: Jul. 11, 2024

(54) First Node and Communications System Methods Performed Thereby, for Handling a Change of a Wireless Device from a First Cell to a Second Cell

(71) Applicant: Telefonaktiebolaget LM Ericsson (publ), Stockholm (SE)

(72) Inventors: Deepak Gupta, Noida (IN); Ayan Sen, Bangalore (IN); Surajit Mondal, Bangalore (IN)

(21) Appl. No.: 18/554,301

(22) PCT Filed: Apr. 13, 2021
(86) PCT No.: PCT/IN2021/050365

§ 371 Date: Oct. 6, 2023

(51) Int. Cl. H04W 36/00

(52) U.S. Cl. CPC H04W 36/0069

(57) ABSTRACT

A method, performed by a first node (111) serving a wireless device (130) in a secondary cell group (122), to handle a change of the device (130) from a first cell (123) to a second cell (124). The first node (111) determines (609) whether to proceed or to suspend the change, with the proviso that a probability of RLF at the first cell (123) is under a threshold. The determining (609) is based on whether or not a predicted quality of communication between the wireless device (130) and the second cell (124) exceeds another threshold. The first node (111) sends (610) an indication to a second node (112) indicating to proceed with the change, wherein the first node (111): i) if the result is to proceed with the change, sends the indication, and ii) if the result is to suspend the change, refrains from sending (610) the indication and suspends the change.

### TECHNICAL FIELD

The present disclosure relates generally to a first node and methods performed thereby for handling a change of a wireless device from a first cell to a second cell. The present disclosure relates generally to a communications system and methods performed thereby for handling the change of the wireless device from the first cell to the second cell. The present disclosure further relates generally to computer program products, comprising instructions to carry out the actions described herein, as performed by the first node and the second node. The computer program products may be stored, respectively, on a computer-readable storage medium.

### BACKGROUND

Wireless devices within a communications network may be e.g., User Equipments (UE), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The communications network covers a geographical area which may be divided into cell areas, each cell area being served by a network node, which may be an access node such as a radio network node, radio node or a base station, e.g., a Radio Base Station (RBS), which sometimes may be referred to as e.g., evolved Node B (“eNB”), “eNodeB”, “NodeB”, “B node”, Next Generation NodeB (gNB), Transmission Point (TP), or BTS (Base Transceiver Station), depending on the technology and terminology used. The base stations may be of different classes such as e.g., Wide Area Base Stations, Medium Range Base Stations, Local Area Base Stations, Home Base Stations, pico base stations, etc. . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

The third generation partnership project (3GPP) is currently working on standardization of the 5th generation of mobile radio access system, also called Next Generation Radio Access Network (NG-RAN). The NG-RAN may include nodes providing radio connections according to the standard for New Radio (NR), the radio access for 5G, as well as nodes providing radio connections according to the Long-Term Evolution (LTE) standard. The NG-RAN may need to be connected to some network that may provide non-access stratum functions and connection to communication networks outside NG-RAN, such as the internet.

### Dual Connectivity in LTE

Evolved Universal Terrestrial Radio Access Network (E-UTRAN) may support Dual Connectivity (DC) operation, whereby a multiple Rx/Tx UE in RRC_CONNECTED may be configured to utilize radio resources provided by two distinct schedulers, located in two eNBs connected via a non-ideal backhaul over the X2 interface (see 3GPP 36.300). DC operation may be understood to advantageously provide data aggregation by using more than one link, as well as link diversity for robustness. eNBs involved in DC for a certain UE may assume two different roles: an eNB may either act as a Master node (MN) or as a Secondary node (SN). In DC, an MN may be understood, for example, as a radio network node which may terminate at least an interface between the radio network node and a Mobility Management Entity (MME). Such an interface may be, for example, an S1 control plane interface between an eNB and an MME (S1-MME). In DC, an SN may be understood as a radio network node that may be providing additional radio resources for a UE, but is not the MN. In DC, a UE may be connected to one MN and one SN.

### LTE-NR Dual Connectivity

In LTE-New Radio (NR) DC, which may be also referred to as LTE-NR tight interworking, the major changes from LTE DC may be understood to be: the introduction of a split bearer from the SN, known as Secondary Cell Group (SCG) split bearer, the introduction of a split bearer for Radio Resource Control (RRC), and the introduction of a direct RRC from the SN, also referred to as SCG Signalling Radio Bearer (SRB). Split RRC messages may be mainly used for creating diversity, and the sender may decide to either choose one of the links for scheduling the RRC messages, or it may duplicate the message over both links. In the downlink, the path switching between the Master Cell Group (MCG) or Secondary Cell Group (SCG) legs, or duplication on both, may be left to network implementation. On the other hand, for the Uplink (UL), the network may configure a UE to use the MCG, SCG or both legs.

The SN may sometimes be referred to as Secondary gNB (SgNB), where gNB is an NR base station, and the MN as Master eNB (MeNB), in case the LTE is the master node and NR is the secondary node. In the other case, where an NR gNB is the master, and an LTE eNB is the secondary node, the corresponding terms may be SeNB and MgNB.

Different dual connectivity scenarios may be distinguished where:
a) DC refers to LTE DC, that is, where both MN and SN employ LTE;
b) EN-DC refers to LTE-NR dual connectivity, where LTE is the master and NR is the secondary;
c) NE-DC refers to LTE-NR dual connectivity, where NR is the master and LTE is the secondary;
d) NR-DC, or NR-NR DC refers to both MN and SN employ NR, and
e) multi-RAT DC, (MR-DC) is a generic term that may be used to describe where the MN and SN employ different RATs. For example, EN-DC and NE-DC are two different example cases of MR-DC.

### Carrier Aggregation

When Carrier Aggregation (CA) is configured, the UE may only have one RRC connection with the network. Further, at RRC connection establishment/re-establishment/handover, one serving cell may provide the Non-Access Stratum (NAS) mobility information, and at RRC connection re-establishment/handover, one serving cell may provide the security input. This cell may be referred to as the Primary Cell (PCell). In addition, depending on UE capabilities, Secondary Cells (SCells) may be configured to form, together with the PCell, a set of serving cells. The configured set of serving cells for a UE may therefore always consist of one PCell and one or more SCells. Further, when dual connectivity is configured, it may be the case that one carrier under the SCG is used as the Primary Secondary Cell (PSCell). Hence, in this case there may be one PCell and one or more SCell(s) over the MCG and one PSCell and one or more SCell(s) over the SCG.

### Radio Link Failure

In LTE, a UE may consider a Radio Link Failure (RLF) to be detected: i) upon detecting a certain number of out of synchronization (out of sync) indications from the lower layers associated with the Primary Cell (PCell) within a given time, or ii) upon a random access problem indication from the Medium Access Control (MAC) layer, or iii) upon indication from the Radio Link Control (RLC) layer that the maximum number of retransmissions has been reached for an SRB or for a Data Radio Bearer (DRB).

When RLF is detected, the UE may prepare an RLF report, which may include, among other information, the measurement status of the serving and neighbor cells at the moment when the RLF was detected. The UE may then go to IDLE mode, select a cell following an IDLE mode cell selection procedure, which may be understood to mean that the selected cell may be the same serving node/cell or another node/cell, and start the RRC re-establishment procedure, with a cause value set to RLF-cause.

In the case of LTE DC, the RLF detection procedure may be understood to be similar to what was described above, except that, only the PCell of the MN may be concerned for (i), the MAC in (ii) may be considered to be the MCG MAC entity, the RLC in (iii) may be considered to be the MCG RLC, and the DRB in (iii) may be considered to correspond to MCG and MCG-split DRBs.

On the other hand, failure on the secondary side, which may be known as an SCGFailure, may be detected by:
a) upon detecting radio link failure for the SCG, in accordance with (i), (ii) and (iii) above, replacing PCell for PSCell, MCG MAC for SCG MAC, and MCG/MCG-Split DRB for SCG DRB, or
b) upon SCG change failure, that is, upon not being able to finalize an SCG change within a certain duration after the reception of an RRC connection reconfiguration message instructing the UE to do so, or
c) upon stopping uplink transmission towards the PSCell due to exceeding the maximum uplink transmission timing difference when powerControlMode is configured to 1.

Upon detecting SCGFailure, the UE may send an SCGFailureInformation message towards the MN, which may also include measurement reports, and the MN may either release the SN, change the SN and/or the Cell, or reconfigure the SCG. Thus, a failure on the SCG may be understood to not lead to a re-establishment to be performed on the MCG.

3GPP has agreed to adopt the same principles in the context of LTE-NR interworking, that is, re-establishment in the case of RLF on the master leg and recovery via SCGFailureInformation and SN release/change/modification in case of RLF on the secondary leg. Specifically, it has been agreed that upon SgNB failures, a UE may need to:
Suspend all SCG DRBs and suspend SCG transmission for MCG split DRBs, and SCG split DRBs;
Suspend direct SCG SRB and SCG transmission for MCG split SRB;
Reset the SCG-MAC; and
Send the SCGFailureInformation message to the MeNB with corresponding cause values.

The Primary Secondary Cell (PSCell) Change procedure may be understood to allow an E-UTRA-NR Dual Connectivity (EN-DC) capable UE to move from the serving SCG Cell to a neighboring SCG Cell. This procedure may involve one of the following two scenarios: an intra-gNB PSCell change and an inter-gNB PSCell change, each of which is described next.

### Intra-gNB PSCell Change

The intra-gNodeB PSCell change sequence may comprise the following steps, which are depicted schematically in FIG. 1. As a pre-condition, an EN-DC capable UE 10 may have already completed an SCG Addition procedure, and connected with an anchor LTE and a SCG Cell in dual connectivity mode. During the SCG addition procedure, the UE may have already received an A3 configuration sent by the MeNB 11 via a RRCConnectionReconfiguration message. The MeNB 11 may have received this information from the SCG cell via an SgNB 12 ADDITION REQUEST ACKNOWLEDGE message during the SCG addition procedure, depicted in FIG. 1 as “SgNB addition”. At step 1, after having added the SgNB 12, the UE 10 may exchange NR UL and Downlink (DL) user data with the PSCell. At step 2, the UE 10 may send an LTE RRC ULInformationTransferMRDC message to the MeNB 11 containing the A3 measurement report which may be forwarded to the SgNB 12 via an X2-AP RRC TRANSFER. At step 3, upon reception of the A3 measurement report, the SgNB 12 may execute an evaluation for the A3 measurement report, comprising, for example, checking the 5G NR Physical Cell Identity (nrPCI), frequency, Managed Object Model (MOM) attribute “isHOAllowed” and cell relation. If the evaluation is passed, the SgNB 12 may send an X2AP:SgNB Modification Required message to the MeNB 11 for handover at Step 4. If the evaluation is failed, the SgNB 12 may send an X2AP: SnNB release Required message to the MeNB 11 with cause “SCG Mobility”. For the next handover, the updated A3 measurement configuration, which may be based on the configuration of the target gNB, may be sent to the UE via an RRC-Reconfiguration message during handover at Step 5. At Step 6, the UE 10 may send an RRCConnectionReconfigurationComplete message to the MeNB 11, who may in turn, at Step 7, send an X2AP: SgNB Modification Confirm message to the SgNB 12. At Step 8, the UE 10 may undergo NR Random Access in the target PSCell with the SgNB 12. Finally, at Step 9. UL and/or DL NR user-data may be resumed in the target PSCell. Also depicted in FIG. 1 is the MME 13.

### Inter-gNB PSCell Change

The inter-gNodeB PSCell change sequence may involve the following steps, as depicted in the schematic diagram of FIG. 2. The pre-condition may be understood to be the same as that of the Intra-gNB PSCell Change described in the preceding section. At step 1, after having added the SgNB 12, the UE 10 may exchange NR UL and DL user data with the PSCell. At step 2, the A3 event may be used to trigger the NR intra-freq PSCell change for EN-DC configured UEs with split bearers, by sending an RRC ULInformationTransfer-ul-DCCH-Message NR to the MeNB 11, who may then send an X2AP: RRC Transfer message to the Source SgNB 12. At step 3, the Source SgNB 12 may receive the A3 measurement report via the MeNB 11, and start an evaluation of the A3 event and, if the reported cell is an intra-freq inter-gNB neighbor of the serving SgNB 12, an X2AP SgNB Change Required message may be sent by the serving SgNB 12 to the MeNB 11 comprising CGConfig and Target SgNB Identity (ID) information. At step 4, the MeNB 11 may evaluate the target NR cell suggested by the source gNB 12 and, if validation is completed, send an X2AP: SgNB Addition Request message to the target gNB 14. The target gNB 14 may respond with an SgNB Addition Request Acknowledge message comprising CGConfig information. At step 5, at the reception of the X2AP: SgNB Addition Request Acknowledge message, the MeNB 11 may trigger an X2AP: SgNB Change Confirm message to the source SgNB 12, and send via RRC, an RRC Connection Reconfiguration message to the UE 10 in parallel. The user data may then be suspended. The source SgNB 12 may send an X2AP: SgNB SN Status Transfer message to the MeNB 11, as well as an X2AP: Secondary RAT usage data report message. The MeNB 11 may trigger an X2AP: SgNB SN Status Transfer message to the target gNB 14. User data may then be resumed, and the MeNB 11 may perform LTE random access with the UE 10. After reception via RRC of the RRC Connection Reconfiguration Complete message from the UE 10, the MeNB 11 may send, an X2AP: SgNB Reconfiguration Complete message to the target SgNB 14. At step 6, the MeNB 11 may send, an S1AP: E-UTRAN Radio Access Bearer (E-RAB) Modification Indication message to the MME 13, to move the S1-U termination of the Split bearer(s) from the source SgNB 12 to the target SgNB 14, after, an X2AP: SN Status Transfer message from the source SgNB 12, in case of AM bearers, and, via RRC, an RRC Connection Reconfiguration Complete message from the UE 10. At step 7, the DL S1-U termination may be changed, and the SCG may send an “end marker” to the source gNB. The source SgNB 12 may receive the “end marker”, and stop packet forwarding, and may then forward “end marker” to the target gNB 14. At step 8, the MME 13 may respond with an S1AP: E-RAB Modification Confirmation message to the MeNB 11. At step After reception of the S1AP: E-RAB Modification Confirmation message, the MeNB 11 may release old resources in the source gNB 12 by sending an X2-AP UE Context Release message to the source SgNB 12. The UE 10 may then perform NR Random Access in the target PSCell. NR UL and/or DL user data may then be resumed in the target PSCell.

### SCG Failure Information

The purpose of this UE initiated procedure may be understood to be to inform EUTRAN or NR MN about an SCG failure the UE has experienced with one of the following causes; t310-Expiry, scg-ChangeFailure, randomAccessProblem, ric-MaxNumRetx,srb3-IntegrityFailure, and scg-reconfigFailure.

FIG. 3 is a schematic block diagram illustrating an example of an SCG failure indication during a PSCell change procedure. At step 1, the MeNB 11 may send an RRC_Connection_Reconfiguration to the UE 10 to indicate a mobility command that that comprise the radio resource configuration information on the target SgNB that may be required by the UE to perform the mobility. At step 2, the MeNB 11 may send an S1_ERAB_Modification_Indication message to the Core Network (CN) 30 to notify the core network e.g., the MME, about the new DL address of the E-RABs. At step 3, the UE 10 may send an RRC_RRC_Connection_Reconfiguration_Complete message to the MeNB 11 to indicate that UE the has successfully applied the new configuration received in the message RRC_Connection_Reconfiguration. At step 4, the MeNB 11 may then send an X2_SGNB_Reconfiguration_Complete message to the SgNB 12. The MeNB 11 may then undergo an Internal_Porc-X2_SGNB_Addition to monitor the overall SgNB addition procedure. At step 5, the CN 30 may send an S1_REAB_Modification_Confirm message to the MeNB 11 to indicate the result for all the E-RABs that were requested to be modified according to the E-RAB To Be Modified Item IEs Information Element (IE) of the E-RAB MODIFICATION INDICATION message. At step 6, the MeNB 11 may send a cu_cp_x2_ue_context_release message to the SgNB 12, who may then execute a du_f1_ue_context_release_command, a cu_cp_f1_ue_context_release_command, a du_f1_ue_context_release_complete, a cu_cp_f1_ue_context_release_complete and a cu_cp_proc_endc_release to monitor the overall SgNB release procedure. At step 7, the UE 10 may send an RRC_SCG_Failure_Information_NR message to the MeNB 11 to indicate that the ENDC connected UE has encountered one of the following failures—SCG RLF, SN change failure, SCG configuration failure, SCG RRC integrity check failure.

The UE may include measurement results available according to a current measurement configuration of both the MeNB and the SgNB in the SCG Failure Information message. The MeNB may handle the SCG Failure Information message and may decide to keep, change, or release the SgNB/SCG. The measurement results and the SCG failure type may be forwarded to the SN.

From the existing deployment of NR Non-standalone (NSA), it has been observed that after evaluating the NR A3 measurement report, the serving SgNB may start the PSCell change procedure to the target NR cell for which the MeNB may have already received multiple consecutive RRC SCG failure information messages from the UE. However, the MeNB may again attempt to add this target NR cell during the PSCell change procedure by sending a SgNB addition request message with a SGNB-Addition-Trigger-Indication as SN change and once again may receive an RRC SCG failure information message from the UE for this same target NR cell. This may keep on repeating until the UE may move to a different LTE anchor cell and may add another SgNB.

FIG. 4 is a schematic diagram depicting an example repeated SCG failure during a PSCell change procedure. Initially, at step 1, an EN-DC capable UE 10 is connected with an anchor LTE Cell-A (MeNB) 41 and an NR SCG Cell-B 42. At step 2, the UE 10 sends an NR A3 measurement report to the NR SCG Cell-B 42, indicating NR SCG Cell-C as the best target candidate. At step 3, the PSCell Change procedure is initiated towards the target NR SCG Cell-C 43. At step 4, during the change procedure, the MeNB received the RRC-SCG Failure Information NR from the UE 10. The MeNB 41 may decide to keep, change, or release the SgNB/SCG. At step 5, the MeNB 41 sends an SgNB Release Request to the NR Cell-B 42. Steps 1 to 5 are repeated multiple times, until the UE 10 moves to a different anchor LTE cell.

The above phenomena adversely impact the Key Performance Indicators (KPI) of the EN-DC setup success rate on both the 4G and the 5G side, the NSA NR retainability and also the user experience in terms of throughput, latency and UE battery life, since the EN-DC capable UE has to measure the NR cell repeatedly until no RRC SCG failure information message is sent by the UE to the MeNB.

According to the foregoing, the exiting methods to perform a PSCell Change procedure may result in a waste of resources in a communications system, such as time-frequency resources, processing resources and energy resources, contributing to an increase of the latency in the communications system, as well as reduced capacity, and depletion of battery power for the devices involved.

### SUMMARY

It is an object of embodiments herein to improve the handling a change of a wireless device from a first cell to a second cell.

According to a first aspect of embodiments herein, the object is achieved by a computer-implemented method, performed by a first node. The first node serves a wireless device in a secondary cell group. The method may be understood to be for handling a change of the wireless device from a first cell to a second cell. The first node operates in a communications system. The first node determines whether to proceed with the change from the first cell to the second cell, or to suspend the change. The determining is performed with the proviso that a probability of RLF for the wireless device at the first cell is lower than a threshold. The determining is based on whether or not a predicted quality of a communication between the wireless device and the second cell exceeds another threshold. The first node also sends, based on a result of the determination, an indication to a second node operating in the communications system. The second node serves the wireless device in a primary cell group. The indication indicates to proceed with the change, wherein: i) with the proviso that the result is to proceed with the change, the first node sends the indication, and ii) with the proviso that the result is to suspend the change, the first node refrains from sending the indication and suspends the change.

According to a second aspect of embodiments herein, the object is achieved by a computer-implemented method, performed by a communications system. The method is for handling the change of the wireless device from the first cell to the second cell. The communications system comprises the first node and the third node 113. The first node serves the wireless device in the secondary cell group. The method comprises initiating determining, by the third node, and using a second machine-learning model, a predicted DL quality in the second cell. The method also comprises providing, by the third node, the predicted DL quality in the second cell to the first node. The method further comprises determining, by the first node, whether to proceed with the change from the first cell to the second cell, or to suspend the change. The determining is performed with the proviso that the probability of RLF for the wireless device at the first cell is lower than the threshold. The determining is based on whether or not the predicted quality of the communication between the wireless device and the second cell exceeds the another threshold. The method further comprises sending, by the first node, based on the result of the determination, the indication to the second node operating in the communications system. The second node serves the wireless device in the primary cell group. The indication indicates to proceed with the change, wherein: i) with the proviso that the result is to proceed with the change, the first node sends the indication, and ii) with the proviso that the result is to suspend the change, the first node refrains from sending the indication and suspends the change.

According to a third aspect of embodiments herein, the object is achieved by the first node. The first node is configured to serve the wireless device in the secondary cell group. The first node is for handling the change of the wireless device from the first cell to the second cell. The first node is configured to operate in the communications system. The first node is further configured to determine whether to proceed with the change from the first cell to the second cell, or to suspend the change. The determining is configured to be performed with the proviso that the probability of RLF for the wireless device at the first cell is lower than the threshold. The determining is further configured to be based on whether or not the predicted quality of the communication between the wireless device and the second cell exceeds the another threshold. The first node is also configured to send, based on the result of the determination, the indication to the second node configured to operate in the communications system. The second node is configured to serve the wireless device in the primary cell group, and the indication is configured to indicate to proceed with the change, wherein: i) with the proviso that the result is to proceed with the change, the first node is configured to send the indication, and ii) with the proviso that the result is to suspend the change, the first node is configured to refrain from sending the indication and suspend the change.

According to a fourth aspect of embodiments herein, the object is achieved by the communications system, for handling the change of the wireless device from the first cell to the second cell. The communications system comprises the first node and the third node. The communications system is configured to serve the wireless device in the secondary cell group. The communications system is configured to determine, by the third node, and using the second machine-learning model, the predicted DL quality in the second cell. The communications system is also configured to provide, by the third node, the predicted DL quality in the second cell to the first node. The communications system is configured to determine, by the first node, whether to proceed with the change from the first cell to the second cell, or to suspend the change. The determining is configured to be performed with the proviso that the probability of RLF for the wireless device at the first cell is lower than the threshold. The determining is configured to be based on whether or not the predicted quality of the communication between the wireless device and the second cell exceeds another threshold. The communications system is further configured to send, by the first node, based on the result of the determination, the indication to the second node configured to operate in the communications system. The second node is configured to serve the wireless device in the primary cell group. The indication is configured to indicate to proceed with the change, wherein: i) with the proviso that the result is to proceed with the change, the first node is configured to send the indication, and ii) with the proviso that the result is to suspend the change, the first node is configured to refrain from sending the indication and suspend the change.

According to a ninth aspect of embodiments herein, the object is achieved by a computer program, comprising instructions which, when executed on at least one processor, cause the at least one processor to carry out the method performed by the first node.

According to a tenth aspect of embodiments herein, the object is achieved by a computer-readable storage medium, having stored thereon the computer program, comprising instructions which, when executed on at least one processor, cause the at least one processor to carry out the method performed by the first node.

By the first node determining whether to proceed with the change from the first cell to the second cell, or to suspend the change, with the proviso that the probability of RLF for the wireless device at the first cell is lower than the threshold, and based on whether or not the predicted quality of the communication between the wireless device and the second cell exceeds another threshold, as well as by then sending the indication based on a result of the determination, the first node may ensure that the wireless device only proceeds with the change from the first cell to the second cell, when it may be more beneficial for the wireless device to do so, and not otherwise. This is because even when the probability of RLF for the wireless device at the first cell is lower than the threshold, the first node may still take into account whether the estimated quality of the communication between the wireless device and the second cell may still make proceeding with the cell change favorable for the wireless device. By taking the decision on whether or not to proceed with the cell change based on both, the conditions at the first cell and the conditions at the second cell, the first node may take an improved handover decision that may be most beneficial to the wireless device. As a consequence, the handover success rate may be improved, by avoiding a change towards a target cell with low predicted quality of communication. This may be understood to in turn enable to provide uninterrupted user plane to the wireless device, restricting handover towards a target cell that may not be beneficial for the wireless device. An improved handover success rate may be understood to result in an improved end-user experience in terms of quality of communication. Moreover, the wireless device may experience a reduction in latency and signaling load, due to a reduced re-attempting of cell change towards the second cell when it demonstrates a predicted low quality of communication. In turn, this may result in improved battery life at the wireless device since, with embodiments herein, the wireless device may be able to avoid having to measure the second cell repeatedly. The method performed by the first node may be particularly beneficial when one or more secondary group failures have been recorded at the target cell.

By the communications system, determining, by the third node, the predicted DL quality in the second cell using the second Machine learning (ML) model, and then providing the predicted DL quality in the second cell to the first node, the first node is enabled to better determine whether it may be beneficial or not for the wireless device to proceed with the cell change or not. This is because the first node may rely not only in an observed DL quality in the second cell, but in the predicted DL quality, thereby avoiding an unfavourable cell change if the DL quality changes for the worse with time.

### BRIEF DESCRIPTION OF THE DRAWINGS

Examples of embodiments herein are described in more detail with reference to the accompanying drawings, according to the following description.

FIG. 1 is a schematic block diagram illustrating an example of an intra-gNB PSCell Change procedure.

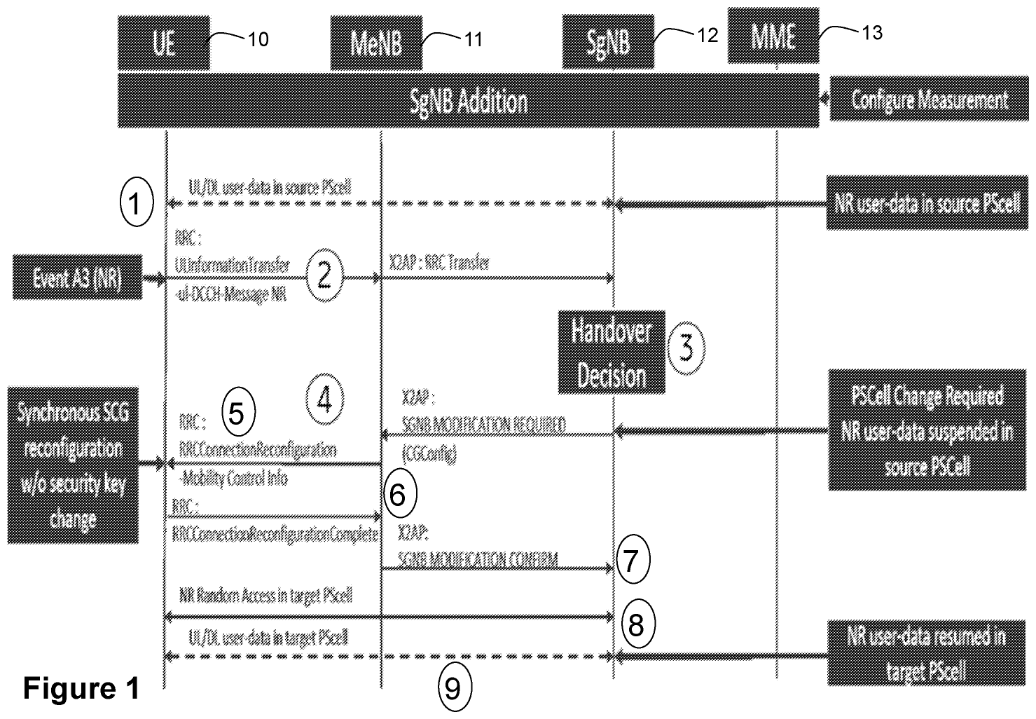

FIG. 2 is a schematic block diagram illustrating an example of an inter-gNB PSCell Change procedure.

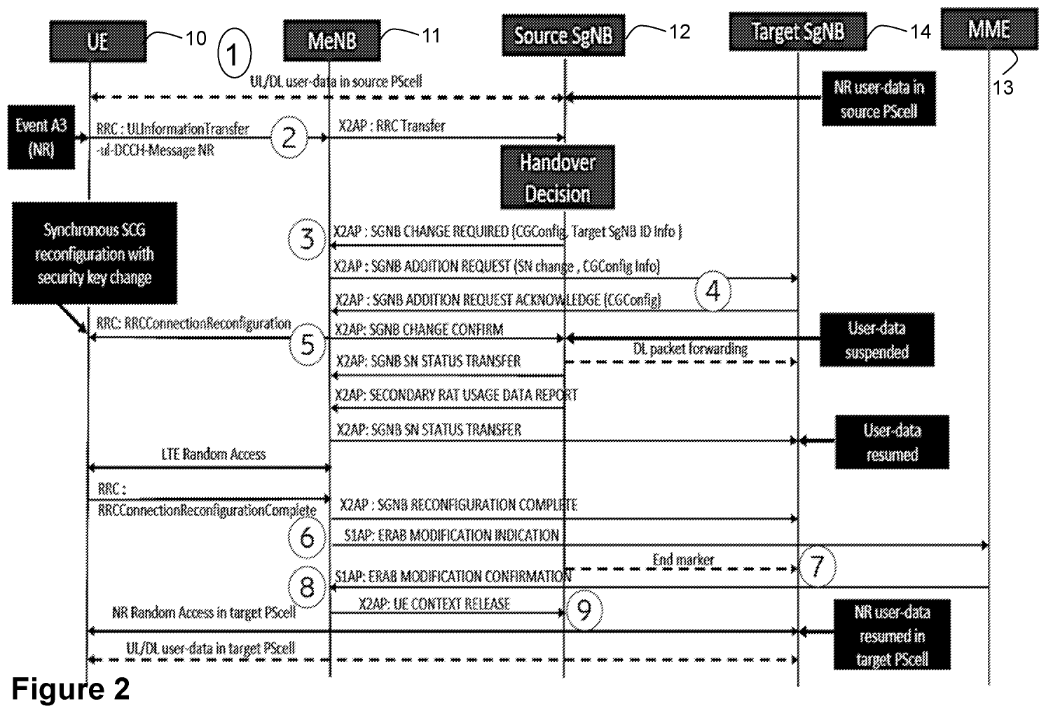

FIG. 3 is a schematic block diagram illustrating an example of an SCG Failure Indication.

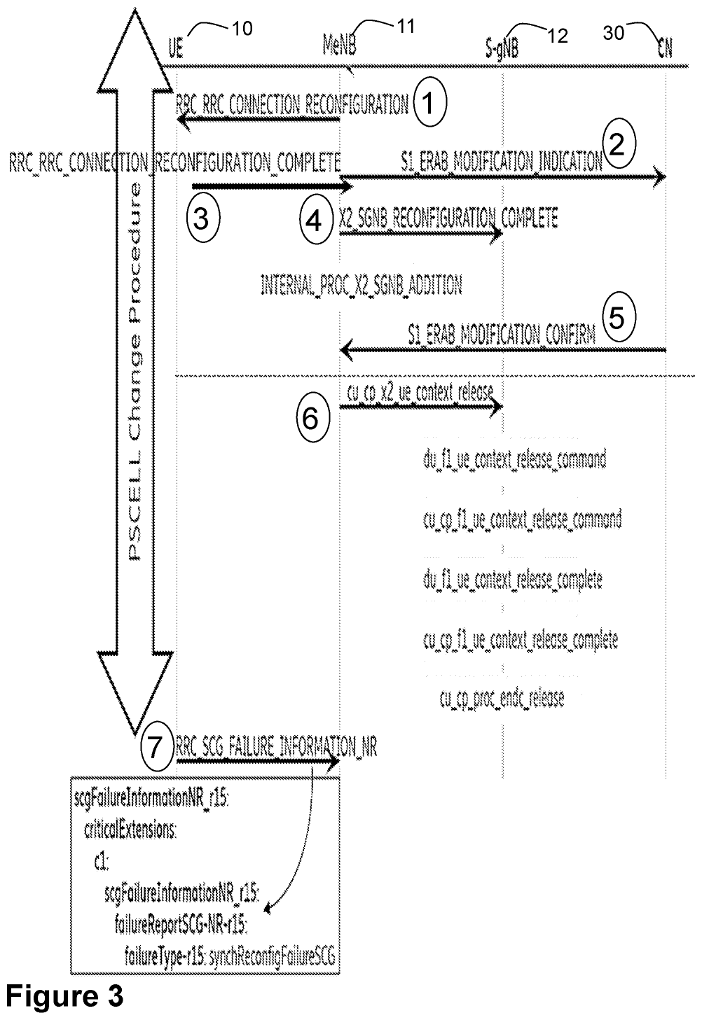

FIG. 4 is a schematic block diagram illustrating an example of repeated SCG failure during a PSCell change procedure.

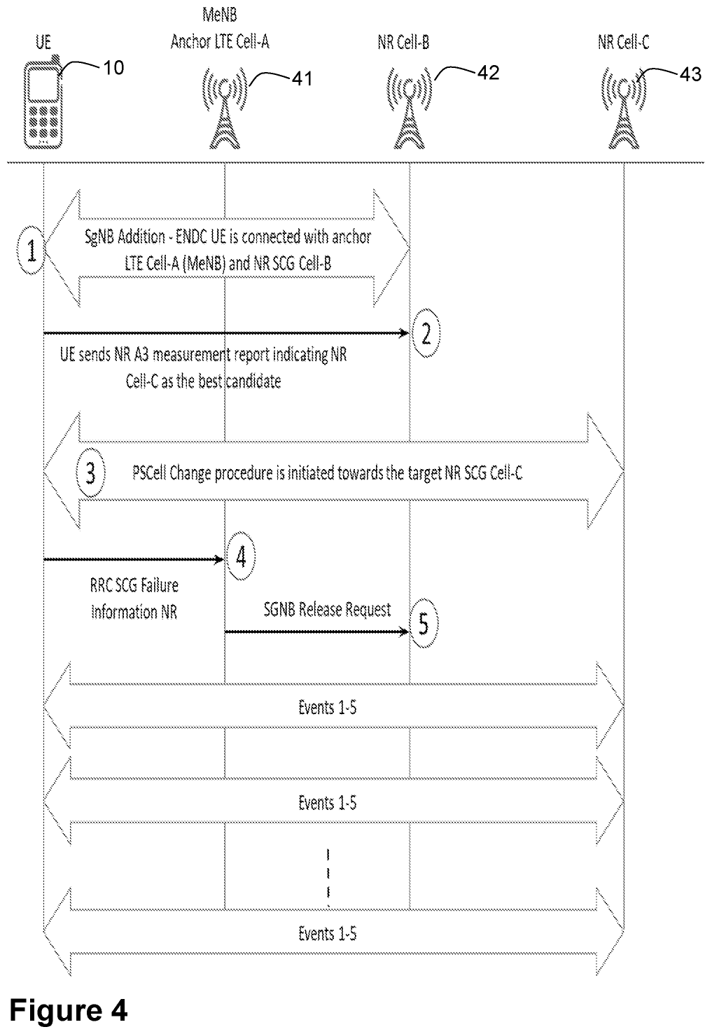

FIG. 5 is a schematic diagram illustrating an example of a communications system, according to embodiments herein.

FIG. 6 is a flowchart depicting a method in a first node, according to embodiments herein.

FIG. 7 is a flowchart depicting a method in a communications system, according to embodiments herein.

FIG. 8 is a schematic diagram illustrating an example of storing SCG Failure Information in an MeNB, according to embodiments herein.

FIG. 9 is a schematic diagram illustrating an example of a flowchart showing proposed solution for handling of SCG failure during a PSCell change procedure, according to embodiments herein.

FIG. 10 is a signaling flow illustrating another example of a method performed by a communications system according to embodiments herein.

FIG. 11 is a schematic diagram illustrating an example of a regressor ML model, according to embodiments herein.

FIG. 12 is a schematic diagram illustrating an example of a classification ML model, according to embodiments herein.

FIG. 13 is a schematic diagram illustrating an example of the accuracy of the model for predicting NR DL Throughput, according to embodiments herein.

FIG. 14 is a flowchart depicting an example of a method in a first node, according to embodiments herein.

FIG. 15 is a flowchart depicting an example of a method in a communications system, according to embodiments herein.

### DETAILED DESCRIPTION

Certain aspects of the present disclosure and their embodiments may be understood to provide solutions to the challenges described in the Background section or other challenges. In general, embodiments herein may be generally understood to relate to methods enabling an improved handling of the EN-DC PSCell Change procedure in a communications system using ML. Embodiments herein may be generally understood to be related to 5G technology and may be particularly applicable to the NR Non-Standalone (NR NSA) case, where an EN-DC capable UE may have simultaneous connectivity to an eNB and an gNB. All EN-DC related control signalling may be understood to happen via an LTE master node and user plane signalling may happen via both LTE and NR, depending upon certain procedures. Embodiments herein may be understood to provide solutions for when an EN-DC capable UE may not be able to access a target NR cell during a PSCell change procedure due to continuous SCG failures from the same target NR cell. Embodiments herein may be used, both, for FR1 and/or FR2 frequency.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Note that although terminology from LTE/5G has been used in this disclosure to exemplify the embodiments herein, this should not be seen as limiting the scope of the embodiments herein to only the aforementioned system. Other wireless systems with similar features, may also benefit from exploiting the ideas covered within this disclosure.

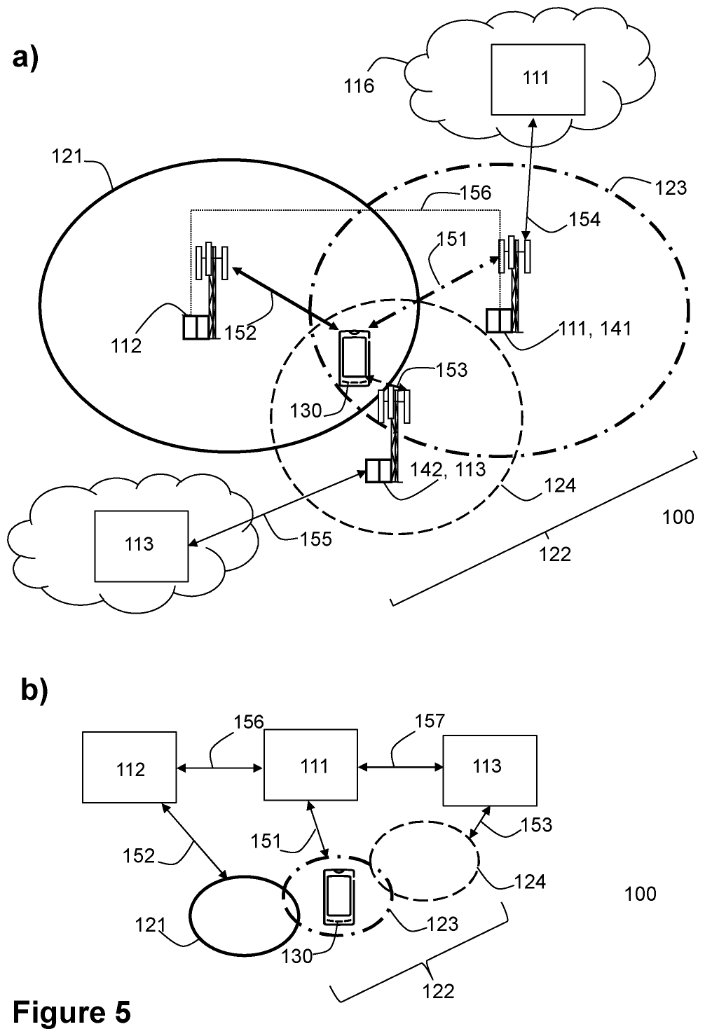

FIG. 5 depicts two non-limiting examples, in panel a) and panel b), respectively, of a wireless network or communications system 100, sometimes also referred to as a wireless communications network, wireless communications system, cellular radio system, or cellular network, in which embodiments herein may be implemented. The communications system 100 may typically be a 5G system, 5G network, or Next Gen System or network, particularly NR NSA, New Radio Unlicensed (NR-U), Licensed-Assisted Access (LAA), or MulteFire, which may support DC, e.g., EN-DC. The wireless communications system 100 may alternatively be a younger system than a 5G system. The communications system 100 may also support other technologies such as, for example, Long-Term Evolution (LTE), LTE-Advanced/LTE-Advanced Pro, e.g. LTE Frequency Division Duplex (FDD), LTE Time Division Duplex (TDD), LTE Half-Duplex Frequency Division Duplex (HD-FDD), LTE operating in an unlicensed band, Wideband Code Division Multiple Access (WCDMA), Universal Terrestrial Radio Access (UTRA) TDD, Global System for Mobile communications (GSM) network, Enhanced Data for GSM Evolution (EDGE) network, GSM/EDGE Radio Access Network (GERAN) network, Ultra-Mobile Broadband (UMB), network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), or any cellular network or system. Thus, although terminology from 5G/NR and LTE may be used in this disclosure to exemplify embodiments herein, this should not be seen as limiting the scope of the embodiments herein to only the aforementioned system.

The communications system 100 comprises a plurality of network nodes, whereof a first node 111, a second node 112 and a third node 113 are depicted in the non-limiting example of FIG. 5. The communications system 100 may comprise other nodes. In typical embodiments, such as that depicted in panel a) of FIG. 5, any of the first node 111, the second node 112 and the third node 113 may be a radio network node, e.g., a transmission point such as a radio base station, or any other network node capable to serve a wireless device, such as a user equipment or a machine type node in the communications system 100. The radio network node may be of different classes, such as, e.g., macro node, home node, or pico base station, based on transmission power and thereby also cell size. In some examples, the radio network node may serve receiving nodes with serving beams. The radio network node may support one or several communication technologies, and its name may depend on the technology and terminology used. Any of the radio network nodes that may be comprised in the communications system 100 may be directly connected to one or more core networks.

In typical examples, the first node 111 may be a first gNB, the second node 112 may be an eNB and the third node 113 may be another gNB.

Any of the first node 111, the second node 112 and the third node 113 may, in some embodiments, be a distributed node, such as a virtual node in the cloud 116, and may perform its functions entirely on the cloud 116, as depicted in the example of panel b), or partially, in collaboration with a radio network node, as depicted in the example of panel a), wherein the first node 111 and the third node 113 perform some of their respective actions in the cloud 116. In panel a), the first node 111 performs some of its functions in the cloud 116 in collaboration with a first radio network node 141, whereas the third network node 113 performs some of its functions in the cloud 116 in collaboration with a second radio network node 142. Also, in some examples, the second node 112 and/or the third node 113 may be co-localized or be the same node.

In examples such as that depicted in panel b), any of the first node 111, the second node 112 and the third node 113 may be understood, respectively, as a first computer system, a second computer system and a third computer system. In some examples, any of the first node 111, the second node 112 and the third node 113 may be implemented as a standalone server in e.g., a host computer in the cloud 116. Yet in other examples, any of the first node 111, the second node 112, the third node 113, the fourth node 114 and the fifth node 115 may also be implemented as processing resources in a server farm.

The communications system 100 may cover a geographical area, which in some embodiments may be divided into cell areas, wherein each cell area may be served by a respective radio network node, although, one radio network node may serve one or several cells. In the example of FIG. 5, the communications system comprises a first cell group or primary cell group 121 and a second cell group or secondary cell group 122. The secondary cell group 122 comprises a first cell 123 and a second cell 124. The primary cell group comprises at least one cell or third cell. The first node 111 may serve the first cell 123, and the third node 113 may serve the second cell 124. The second node 112 may be understood to manage the primary cell group 121 and serve the third cell.

In some particular examples, the second node 112 may be a MN, e.g., a MeNB, the first node 111 may be a first SN and the third node 113 may be a second SN. The first node 111 may be a source SN serving a wireless device, such as the wireless device 130 described below, that is, the first node 111 may be a serving SgNB, and the third node 113 may be a target SN, e.g., a target SgNB, for the wireless device 130.

A plurality of user equipments may be located in the wireless communication network 100, whereof a wireless device 130, is depicted in the non-limiting example of FIG. 5. The wireless device 130 comprised in the communications system 100 may be a wireless communication device such as a 5G UE, or a UE, which may also be known as e.g., mobile terminal, wireless terminal and/or mobile station, a mobile telephone, cellular telephone, or laptop with wireless capability, just to mention some further examples. Any of the wireless devices comprised in the communications system 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in a communications system. The wireless device 130 comprised in the communications system 100 may be enabled to communicate wirelessly in the communications system 100. The communication may be performed e.g., via a RAN, and possibly the one or more core networks, which may be comprised within the communications system 100. The wireless device 130 may support EN-DC.

The first node 111 may be configured to communicate within the communications system 100 with the wireless device 130 over a first link 151, e.g., a radio link. The second node 112 may be configured to communicate within the communications system 100 with the wireless device 130 over a second link 152, e.g., a radio link. The third node 113 may be configured to communicate within the communications system 100 with the second node 112 over a third link 153, e.g., a radio link. The first radio network node 141 may be configured to communicate within the communications system 100 with its respective virtual node in the cloud over a fourth link 154. The second radio network node 142 may be configured to communicate within the communications system 100 with its respective virtual node in the cloud over a fifth link 155. The first node 111 may be configured to communicate within the communications system 100 with the second node 112 over a sixth link 156, e.g., a radio link or a wired link. The first node 111 may be configured to communicate within the communications system 100 with the third node 113 over a seventh link 157, e.g., a radio link or a wired link. The second node 112 may be configured to communicate within the communications system 100 with the third node 113 over an eighth link, e.g., a radio link or a wired link, which is not depicted in FIG. 5 to simplify the figure.

It may be understood that FIG. 5 is schematic and that the number of network nodes and/or cells depicted is not limiting.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first”, “second” and/or “third” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

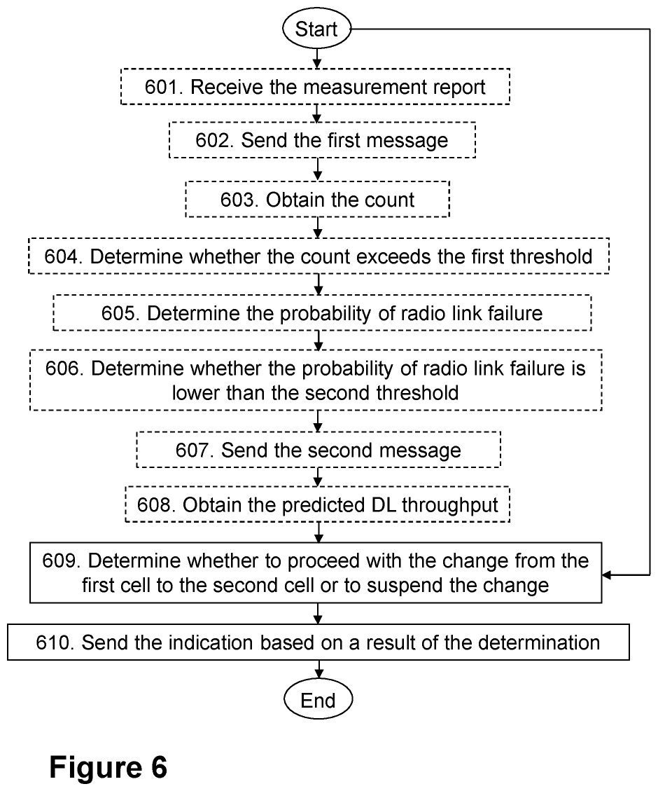

Embodiments of a computer-implemented method, performed by the first node 111, will now be described with reference to the flowchart depicted in FIG. 6. The first node 111 serves the wireless device 130 in the secondary cell group 122. The method may be understood to be for handling a change of the wireless device 130 from the first cell 123 to the second cell 124. The first node 111 operates in the communications system 100.

Several embodiments are comprised herein. In some embodiments all the actions may be performed. In other embodiments, two or more actions may be performed. It should be noted that the examples herein are not mutually exclusive. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description. A non-limiting example of the method performed by the first node 111 is depicted in FIG. 6. In FIG. 6, actions which may be optional in some examples are depicted with dashed boxes.

### Action 601

In the course of operations of the communications system 100, the wireless device 130 may move, and its coverage by different cells and/or beams may change. According to this, the wireless device 130 may be located in the first cell 123 and being served by the first node 111. As the wireless device 130 moves, the wireless device 130 may perform measurements in the cells it may enter, that is, for example, in reference signals transmitted in those cells. One of the cells the wireless device 130 may become under the coverage of may be the second cell 124. When the measurements performed by the wireless device 130 on the second cell 124 meet a certain condition, as configured in the wireless device 130, the wireless device 130 may send a measurement report to the network node serving it.

According to the foregoing, in this Action 601, the first node 111 may receive a measurement report from the wireless device 130 on the second cell 124.

The receiving in this Action 601 may be performed, e.g., via the first link 151.

The measurement report may comprise at least one of: an NR A3 measurement report, an indication, referred to herein as a “second indication” of downlink coverage, another indication, referred to herein as a “third indication” of downlink signal-to-noise and interference ratio, and yet another indication, referred to herein as a “fourth indication”, of a Reference Signal Received Quality.

By receiving the measurement report in this Action 601, the first node 111 may be enabled to know if there is a better cell than the first cell 123 that may be able to serve the wireless device 130, and may therefore trigger, or not, a PSCell Change procedure towards the second cell 124.

### Action 602

With the proviso that the measurement report indicates that the second cell 124 may provide a better coverage to the wireless device 130 than the first cell 121, the first node 111 may then determine if the second cell 124, that is, the candidate target cell, may be sufficiently reliable to serve the wireless device 130, and therefore if it may be worth it to perform a PSCell Change procedure towards it.

According to the foregoing, in this Action 602, the first node 111 may send, based on the received measurement report, a first message to the second node 112. The second node 112 serves the wireless device 130 in a primary cell group 121. The first message may request a count of consecutive secondary cell group failures at the second cell 124.

The sending in this Action 602 may be performed, e.g., via the sixth link 156 for example, over X2 private message.

In some particular examples, the first node 111 may be a Secondary Node (SN), and the second node 112 may be a Master Node (MN). For example, in this Action 601, upon reception of an NR A3 measurement report, the first node 111, e.g., a serving SgNB, may evaluate the A3 NR measurement report and, at the same time, request the second node 112, e.g., a MeNB, for stored historical SCG failures information of the second cell 124, e.g., a target NR cell. The second cell 124 may be identified by the NR Physical-layer Cell Identity (PCI), which may correspond to the strongest NR cell reported in the NR A3 Measurement Report. The strongest cell may be determined, for example, based on a synchronization signal Reference Signal Received Power (ss-RSRP) and/or synchronization signal Reference Signal Received Quality (ss-RSRQ)

The count of consecutive secondary cell group failures at the second cell 124 may be monitored over a time period. The time period may be defined by the timer timerscgfailureNRA3. The timer timerscgfailureNRA3 may be understood as a new proposed parameter which may define a time sliding window during which SCG failures may be maintained in for each active UE Context, such as for the wireless device 130, and Target NR PCI, such as second cell 124. The parameter timerscgfailureNRA3 may have a Range: {0 . . . 100}, a Unit: in seconds, and may have a scope internal to the second node 112, e.g., an eNB, which may be operator configurable. During the course of operations of the communications system 100, the second node 112, e.g., an MeNB, upon receiving any RRC SCG Failure Information message from the wireless device 130, that is, an active EDC UE, may store that information. The second node 112 may maintain a table that may contain the count of SCG failure(s) of all the active ENDC UE contexts, at least for a time window defined and limited by a configurable timer, e.g., the timerscgfailureNRA3. After reception of a SCG failure from the wireless device 130, if the SCG failure information already exists in the table for the wireless device 130 context, the second node 112 may update the table by incrementing the SCG failure count for the given wireless device 130 context and the NR PCI of the target NR Cell, e.g., the second cell 124, by 1. If no previous record exists for the context of the wireless device 130, a new record may be added in the table for the context of the wireless device 130 and the NR PCI of the target NR cell, e.g., the second cell 124, with count of SCG failures set to 1.

At the same time, the second node 112 may reset or restart the timer timerscgfailureNRA3 for the same context of the wireless device 130.

If no new SCG failure information is received for a given context of the wireless device 130 during the time period defined by timerscgfailureNRA3, that is, if the timer timerscgfailureNRA3 expires before receiving any new SCG failure information for the given wireless device 130, the stored SCG failure information for the context of the wireless device 130 may be purged.

If the context of the wireless device 130 is released, the context of the wireless device 130 may be released for both the NR and the LTE anchor leg, and the stored SCG failure information for the context of the wireless device 130 may be purged.

By sending the first message to the second node 112 in this Action 602, the first node 111 may be enabled to obtain the requested count of consecutive secondary cell group failures at the second cell 124, and thereby know if the second cell 124 is a reliable cell with a good track record of performance, or whether it has a history of consecutive secondary cell group failures, and consider this information to determine whether the wireless device 130 may need to refrain with proceeding with a PSCell Change procedure towards it.

### Action 603

In this Action 603, the first node 111 may obtain, from the second node 112, the count of consecutive secondary cell group failures at the second cell 124.

The obtaining in this Action 603 may comprise receiving, retrieving or similar, and it may be performed, e.g., via the sixth link 156. The first node 111 may obtain the count from the second node 112 by receiving an X2 Private Message.

By obtaining the count of consecutive secondary cell group failures at the second cell 124 in this Action 603, the first node 111 may be enabled to determine, in the next action, whether the second cell 124 is a reliable cell with a good track record of performance, or whether it has a history of consecutive secondary cell group failures, and therefore the wireless device 130 may need to refrain with proceeding with a PSCell Change procedure towards it.

### Action 604

In this Action 604, the first node 111 may determine whether or not the count of consecutive secondary cell group failures at the second cell 124 exceeds a first threshold.

Determining may be understood here as e.g., calculating, deciding or detecting.

The first threshold may be, for example, a new parameter that may define a threshold of a count of consecutive SCG failures in a target NR cell. That is, the first threshold may be understood to be a failure threshold. The first threshold may be referred to herein as cnscgfailurethresh. The first threshold may have a range of {0 . . . 1000}, and a unit in absolute numbers. The scope may be internal to the first node 111, e.g., an SgNB, and may be operator configurable.

By determining whether or not the count of consecutive secondary cell group failures at the second cell 124 exceeds the first threshold in this Action 604, the first node 111 may be enabled to later consider, in Action 609, whether to proceed with the change from the first cell 123 to the second cell 124, or whether to suspend the change. This may be understood to be because if the second cell 124 has a history of repeated secondary cell group failures, it may not be beneficial for the wireless device 130 to proceed with the change to the second cell 124, only to experience a failure.

### Action 605

In this Action 605, the first node 111 may determine, using a classification machine-learning (ML) model, the probability of RLF for the wireless device 130 at the first cell 123.

Determining may be understood as e.g., calculating, deciding or detecting.

The classification ML model may enable the first node 111 to predict whether the probability of radio link failure for the wireless device 130 at the first cell 123 falls into a “low” probability category, or a “high” probability category.

The classification ML model may be, for example, a K-Nearest Neighbors (K-NN) Classification ML model, or another classification model, such as a Random Forest Classifier, a Decision Tree Classifier, or a Neural Network (NN).

The classification ML model may use various measurements, which may be also referred to as “features”, which may be available to the first node 111 from the wireless device 130, and/or measurements that may have been performed by the first node 111 on communication channels and internal modules Table 1 provides a description of the features that may be used for the classification ML model in this Action 605. The features used by the first node 111 may have been selected based on the Chi-Square scores and associated p-values for the dependent variable, which may be understood to be probability of NR RLF in the first cell 123. There may be, in general terms, two types of features used for the classification ML model. A first type of features may be based on the various measurements that may be available to the first node 111 from the wireless device 130. Such first type of features may comprise one or more of, for example: a downlink coverage measurement, such as a Synchronization Signal reference signal received power (SS-RSRP), a Secondary synchronization Signal Reference Signal Received Quality (SS-RSRQ), a Radio frequency (RF) Channel quality indicator (CQI). Another type of features may be the various measurements that may have been performed by the first node 111 on the communication channels and internal modules. Such first type of features may comprise one or more of, for example: a downlink Modulation Coding Scheme (MCS), e.g., Layer 1 DL MCS, for example, and Average (Avg) of such MCS, a downlink number of Physical Downlink Shared Channel (PDSCH) Resource Blocks (RBs), e.g., Layer 1 DL RB Num, for example, and Average (Avg) of such DL RB Num, a ratio of utilization of the PDSCH, e.g., a total number of allocated DL slots to the PDSCH over a total number of allocated PDSCH DL slots, a ratio of utilization of the Physical Uplink Shared Channel (PUSCH), e.g., a total number of allocated UL slots to the PUSCH over a total number of allocated PUSCH UL slots, a ratio of a DL Radio Link Control (RLC) Block error rate (BLER) over a total RLC BLER, a ratio of an UL RLC BLER over a total RLC BLER, and a ratio of retransmitted Packet Data Units (PDUs) over a total number of transmitted PDUs in the UL.

TABLE 1

| Feature | Description |
|---|---|
| TA | Timing Advance |
| SS-RSRP [dBm] | Based on UE measurement report, indicates |
| | NR DL coverage |
| SS-RSRQ [dB] | Based on UE measurement report, indicates |
| | DL quality |
| RF CQI | Channel quality indicator reported by UE |
| Layer1 DL MCS (Avg) | DL modulation & coding scheme |
| Layer1 DL RB Num (Avg) | DL PDSCH resource blocks |
| PDSCH Slot Utilization | Ratio of total allocated dl slots and total dl |
| Ratio [%] | slots |
| PUSCH Slot Utilization | Ratio of total allocated ul slots and total ul |
| Ratio [%] | slots |
| RLC DL BLER Total [%] | DL BLER on RLC layer |
| RLC UL BLER Total [%] | UL BLER on RLC layer |
| RLC Retx Info UL Retx | Ratio of retransmitted PDUs to total |
| Rate Total | transmitted PDUs in UL |

Table 2 depicts a non-limiting example of a result the first node 111 may obtain in the determination performed in this Action 605 using a K-NN classification model. Particularly, Table 2 shows a confusion matrix obtained with the K-NN classification model, with accuracy of the model of 99.41%.

TABLE 2
Accuracy of the classification ML model for predicting
the probability of RLF on the first cell 123.
Accuracy: 99.41%

| Confusion Matrix | Predicted: Low | Predicted: High |
|---|---|---|
| Actual: Low | 98.13% | 0.12% |
| Actual: High | 0.47% | 1.29% |

The first node 111 may perform the determining in this Action 605, based on a result of the determining in Action 604. That is, the first node 111 may determine the probability of radio link failure for the wireless device 130 at the first cell 123 with the proviso that the count of consecutive secondary cell group failures at the second cell 124 exceeds, or is equal to, the first threshold.

By determining the probability of RLF for the wireless device 130 at the first cell 123 using the classification ML model, the first node 111 may be able to know, independently of a particular punctual measurement, what may be the predicted probability of RLF for the wireless device 130 at the first cell 123, and thereby better evaluate whether the wireless device 130 may need to proceed with the PSCell Change procedure towards the second cell 124, in case the probability of RLF is high, or whether it may be more advisable for the wireless device 130 to remain in the first cell 123, if the probability of RLF is low.

### Action 606

In this Action 606, the first node 111 may determine whether the determined probability of RLF for the wireless device 130 at the first cell 123 falls within a first category of probabilities being lower than a threshold. The threshold may be a second threshold. The second threshold may be understood to separate different categories of probabilities, such as a first, “low”, probability category, and a second, “high”, probability category.

By determining whether the determined probability of RLF for the wireless device 130 at the first cell 123 falls within the category of probabilities being lower than the second threshold, the first node 111 may be able to know whether the wireless device 130 may need to proceed with the PSCell Change procedure, in case the probability of RLF falls within the second, “high” probability category, or whether it may be more advisable for the wireless device 130 to remain in the first cell 123, if the probability of RLF falls within the first “low” probability category, as will be described in the following actions.

If the determined probability of RLF at the first cell 123 is high, then the first node 111 may determine that the radio conditions may not be favorable to retain the context of the wireless device 130, and that it may drop the context abnormally. The first node 111 may then proceed to perform Action 610 to continue PSCell Change procedure.

### Action 607

If the determined probability of RLF at the first cell 123 is found to be low, that is, if it falls within the first category of probabilities lower than the second threshold, the first node 111 may determine that it can still retain the context for the wireless device 130 without dropping it abnormally due to bad radio conditions. However, the first node 111 may still want to obtain more information about the second cell 124 before deciding to refrain from continuing with the PSCell Change procedure. Particularly, the first node 111 may want to compare the DL throughput the wireless device 130 may be receiving at the first cell 123, with the DL throughput which it may receive at the second cell 124.

In this Action 607, the first node 111 may send, with the proviso that the determined probability of RLF for the wireless device 130 at the first cell 123 falls within the first category of probabilities being lower than the second threshold, a second message to the third node 113 managing the second cell 124. The second message may request the predicted DL throughput in the second cell 124.

The sending in this Action 607 may be performed, e.g., via the seventh link 157. The second message may be a private X2 message.

In some embodiments, the first node 111 may also send, in the second message or a in a separate message, a current Reference Signal Received Power (RSRP), Reference Signal Received Quality (RSRQ), Signal-to-Noise and Interference Ratio (SINR), Timing advance (TA) and Angle of arrival (AoA) along with capacity related metrics to the third node 113.

By sending the second message to the third node 113, the first node 111 may be enabled to then obtain the predicted DL throughput in the second cell 124, and thereby take this into account when considering whether it may be favourable or not for the wireless device 130 to proceed with the change towards the second cell 124.

### Action 608

After receiving the second message, the third node 113 may transform the received TA and AoA into distance and bearing with respect to its own location coordinates and cell azimuth. This transformed information may then be used by the third node 113 to adjust the reported RSRP, RSQ and SINR with respect to the second cell 124. Using the derived features, the third node 113 may apply another ML model, which may be referred to herein as a second model, e.g., a Random Forest Regression ML Model, to predict the throughput that may be achieved with the given condition and may then send the predicted throughput value to the first node 111. Other regression ML models may also be used. For example, Support Vector Regression, Decision Tree Regression and even NN.

The second ML model run by the third node 113 may use the features described in Table 3. The features used by the third node 113 may have been selected based on the Chi-Square scores and associated p-values for the dependent variable, which may be understood to be DL throughput, e.g., NR DL throughput. As before, for the second ML model as well, there may be two types of features used. The first type of features may be based on the various measurements that may be available to the first node 111 from the wireless device 130. Such first type of features may comprise one or more of, for example: the DL coverage measurement, such SS-RSRP, and the DL SINR, e.g., the Synchronization Signal SINR (SS-RSRQ). Another type of features may be the various measurements that may have been performed by the first node 111 on the communication channels and internal modules. Such first type of features may comprise one or more of, for example: the DL MCS, e.g., Avg. DL MCS, for example, the DL number of PDSCH Resource Blocks, e.g., the Avg. DL RB Num, and a number of DL layers, e.g., for Layer 1, such as for example, an Avg. DL Layer Num.

TABLE 3

| Feature | Description |
|---|---|
| SS-RSRP [dBm] | Based on UE measurement report, |
| | indicates NR DL coverage |
| SS-SINR [dB] | Based on UE measurement report, |
| | indicates DL SS signal-to-noise |
| | and interference ratio |
| DL MCS (Avg) | DL modulation & coding scheme |
| DL RB Num (Avg) | DL PDSCH resource blocks |
| DL Layer Num (Avg) | Layer1 DL Layer Num |

In this Action 608, the first node 111 may obtain, based on the sent second message, the predicted DL throughput in the second cell 124 from the third node 113.

The obtaining, which may comprise receiving or retrieving in this Action 608, may be performed, e.g., via the seventh link 157.

By obtaining the predicted DL throughput in the second cell 124 from the third node 113 in this Action 608, the first node 111 may be able to make a better decision in the next Action 609, on whether to proceed with the change from the first cell 123 to the second cell 124, or whether to suspend the change, since the first node 111 may have more information to decide whether the change to the second cell 124 may be more beneficial for the wireless device 130 or not, as explained in further detail next.

### Action 609

In this Action 609, the first node 111 may determine whether to proceed with the change from the first cell 123 to the second cell 124, or to suspend the change. The determining in this Action 609 may be performed with the proviso that the probability of RLF for the wireless device 130 at the first cell 123 is lower than the threshold, that is, the second threshold, as determined in Action 606. The determining in this Action 609 is also be based on whether or not a predicted quality of a communication between the wireless device 130 and the second cell 124 exceeds another threshold. The another threshold may be understood as a third threshold. The another threshold may be understood to define a quality threshold. In particular embodiments, the predicted quality of the communication between the wireless device 130 and the second cell 124 may be a DL throughput. The another threshold may be based on a ratio of a current DL throughput in the first cell 123 over the predicted DL throughput in the second cell 124, as obtained in Action 608. The another threshold may be understood to particularly define, in some examples, a DL throughput threshold. The another threshold may be referred to as a new configurable parameter used as threshold for comparing an estimated NR DL throughput in the first cell 123, e.g., the serving NR cell, with a predicted DL NR throughput in the second cell 124, e.g., the Target NR cell. The another threshold may be referred to herein as ratservtargNrDL. The another threshold may have a range of {0 . . . 1}, and a unit in ratio. The scope may be internal to the first node 111, e.g., an SgNB, and may be operator configurable. According to the foregoing, in this Action 609, the first node 111 may check the following condition:

$$\frac{Current NR DL Throughput at Serving NR Cell}{Predicted NR DL Throughput at Target NR Cell} > ratservtargNrDL$$

If the condition is true, then the first node 111 may determine that the PSCell Change will likely not yield a better experience for the end user of the wireless device 130, and hence may decide to suspend or discontinue the PSCell Change procedure.

The determining in this Action 609 of whether to proceed with the change from the first cell 123 to the second cell 124, or to suspend the change, may be based on whether or not the determined count in Action 604 exceeds the first threshold. This may be understood to mean that the first node 111 may proceed with a) determining whether the determined probability of RLF for the wireless device 130 at the first cell 123 falls within the first category of probabilities being lower than the second threshold, and with b) comparing the ratio of the current DL throughput in the first cell 123 over the predicted DL throughput in the second cell 124 only if the determined count of consecutive secondary cell group failures at the second cell 124 exceeds the first threshold. In other words, the first node 111 may only proceed with a more in-depth examination of whether it may be beneficial for the wireless device 130 to proceed with the change to the second cell 124, if there is a sign it may not be, as indicated by the count of consecutive secondary cell group failures at the second cell 124 exceeding the first threshold, in spite of the measurement report having indicated that the second cell 124 may provide better coverage than the first cell 123.

By determining whether to proceed with the change from the first cell 123 to the second cell 124, or to suspend the change in this Action 609, the first node 111 may ensure that the wireless device 130 only proceeds with the change from the first cell 123 to the second cell 124, when it may be more beneficial for the wireless device 130 to do so, and not otherwise.

### Action 610

In this Action 610, the first node 111 may send, based on a result of the determination in Action 609, an indication to the second node 112 operating in the communications system 100. The second node 112 serves the wireless device 130 in the primary cell group 121. The indication indicates to proceed with the change, wherein: i) with the proviso that the result is to proceed with the change, the first node 111 sends the indication, and ii) with the proviso that the result is to suspend the change, the first node 111 refrains from sending 610 the indication and suspends the change.

If the condition is false, namely, if the ratio of the current DL throughput in the first cell 123 over the predicted DL throughput in the second cell 124 is smaller than the another threshold, then the first node 111 may determine that the PSCell Change will likely yield a considerable benefit in terms of end-user experience of the wireless device 130, and hence the first node 111 may send the indication to continue with the PSCell Change procedure.

If the determined probability of RLF at the first cell 123, as determined in Action 606, is high, the first node 111 may then send the indication to the second node 112 to continue PSCell Change procedure.

The sending in this Action 610 may be performed, e.g., via the sixth link 156. The indication may be, for example an “SgNB change required message” or a “SgNB modification required message”, to continue PSCell Change procedure.

By, in this Action 610, sending the indication to the second node 112 based on the result of the determination performed in Action 609, the first node 111 may ensure that the wireless device 130 only proceeds with the change from the first cell 123 to the second cell 124 when it may be more beneficial for the wireless device 130 to do so, and not otherwise, taking into consideration the count of SCG failures at the second cell 124, the probability of RLF in the first cell 123, and the DL throughput achieved at the first cell 123 in comparison with the one predicted at the second cell 124. As a consequence, the handover success rate may be improved, by avoiding a PSCell change towards a target cell observed with high handover and/or SCG addition failures. This may be understood to in turn enable to provide uninterrupted user plane to the wireless device 130, restricting handover towards a target cell a high SCG failure may have been reported historically. An improved handover success rate may be understood to result in an improved end-user experience in terms of throughput. Moreover, the wireless device 130 may experience a reduction in latency and signaling load on the side of the second node 112, that is the LTE side, due to a reduced re-attempting of PSCell change towards the second cell 124 when it demonstrates a high SCG Failure. In turn, this may result in improved battery life at the wireless device 130 since, with embodiments herein, the wireless device 130 may be able to avoid having to measure the second cell 124 repeatedly.

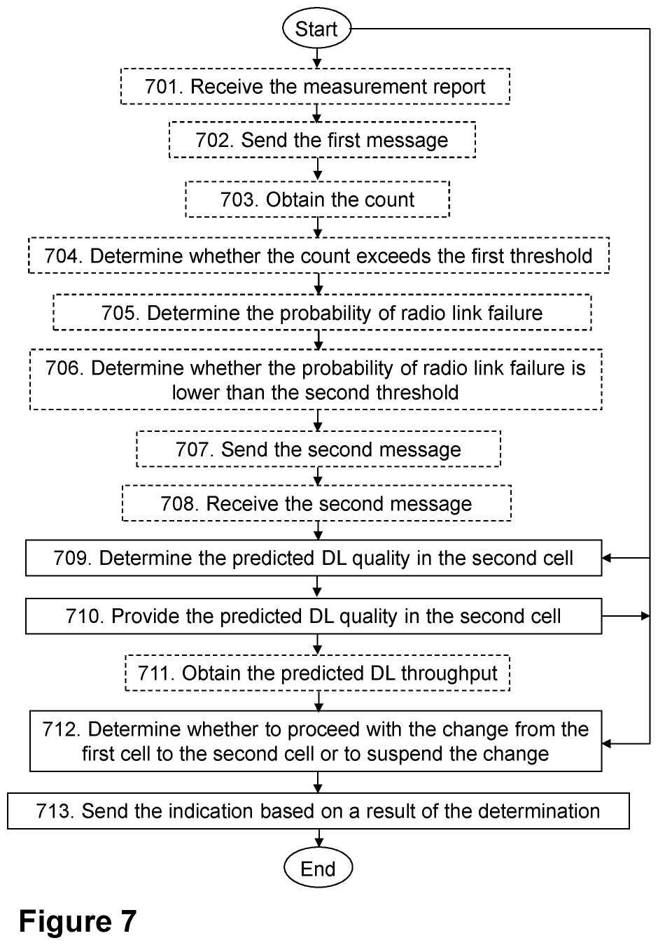

Embodiments of a computer-implemented method, performed by the communications system 100, will now be described with reference to the flowchart depicted in FIG. 7. The method may be understood to be for handling the change of the wireless device 130 from the first cell 123 to the second cell 124. The communications system 100 comprises the first node 111 and the third node 113. The first node 111 serves the wireless device 130 in the secondary cell group 122.

The method may comprise the actions described below. In some embodiments some of the actions may be performed. In some embodiments all the actions may be performed. In FIG. 7, optional actions are indicated with a dashed box. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples.

The detailed description of the Actions depicted in FIG. 7 may be understood to correspond to that already provided when describing the actions performed by each of the first node 111 and the second node 112, as well as the third node 113, and will therefore not be repeated here. Any of the details and/or embodiments already described earlier, e.g., on the thresholds, the ML models, etc. . . . may be understood to equally apply to the description below. For example, in some embodiments, the first node 111 may be an MeNB, the second node 112 may be a Serving SgNB and the third node 113 may be a target SgNB.

### Action 701

This Action 701, which corresponds to Action 601, comprises, receiving, by the first node 111, the measurement report from the wireless device 130 on the second cell 124.

The measurement report may comprise at least one of: the NR A3 measurement report, the second indication of downlink coverage, the third indication of downlink signal-to-noise and interference ratio, and the fourth indication of the Reference Signal Received Quality.

### Action 702

In some embodiments, the method may comprise, in this Action 702, which corresponds to Action 602 sending, by the first node 111, based on the received measurement report, the first message to the second node 112. The first message may request the count of consecutive secondary cell group failures at the second cell 124.

The count of consecutive secondary cell group failures at the second cell 124 may be monitored over the time period

### Action 703

In some embodiments, the method may comprise, in this Action 703, which corresponds to Action 603, obtaining, by the first node 111, from the second node 112, the count of consecutive secondary cell group failures at the second cell 124.

### Action 704

In some embodiments, the method may comprise, in this Action 704, which corresponds to Action 604, determining, by the first node 111, whether or not the count of consecutive secondary cell group failures at the second cell 124 exceeds the first threshold.

### Action 705

This Action 705, which corresponds to Action 605, comprises determining, by the first node 111, using the classification ML model, the probability of RLF for the wireless device 130 at the first cell 123.

### Action 706

This Action 706, which corresponds to Action 606, may comprise, determining, by the first node 111, whether the determined probability of RLF for the wireless device 130 at the first cell 123 falls within the first category of probabilities being lower than the threshold, the threshold being the second threshold.

### Action 707

This Action 707, which corresponds to Action 607, may comprise sending, by the first node 111, with the proviso that the determined probability of RLF for the wireless device 130 at the first cell 123 falls within the first category of probabilities being lower than the second threshold, the second message to the third node 113. The third node 113 may manage the second cell 124. The second message may request the predicted DL throughput in the second cell 124.

### Action 708

In some embodiments, the method may comprise, in this Action 708 receiving 708, by the third node 113, the second message.

### Action 709

In some embodiments, the method comprises, in this Action 709, determining, by the third node 113, and using the second ML model, the predicted DL quality in the second cell 124.

In some embodiments, the second ML model may be a regressor model.

The determining in this Action 709, of the predicted DL throughput in the second cell 124 may be triggered by the received second message.

The predicted quality of the communication between the wireless device 130 and the second cell 124 may be DL throughput. The another threshold may be based on the ratio of the current DL throughput in the first cell 123 over the predicted DL throughput in the second cell 124.

### Action 710

In some embodiments, the method comprises, in this Action 710, providing, by the third node 113, the predicted DL quality in the second cell 124, to the first node 111. This may be performed by sending an X2 private message comprising the predicted DL quality in the second cell 124, e.g., the predicted NR DL throughput in the target NR cell, e.g., via the seventh link 157.

### Action 711

In some embodiments, the method may comprise, in this Action 711, which corresponds to Action 608, obtaining, by the first node 111, based on the sent second message, the predicted DL throughput in the second cell 124 from the third node 113.

### Action 712

In some embodiments, the method comprises, in this Action 712, which corresponds to Action 609, determining, by the first node 111, whether to proceed with the change from the first cell 123 to the second cell 124, or to suspend the change. The determining in this Action 712, 609 is performed with the proviso that the probability of RLF for the wireless device 130 at the first cell 123 is lower than the threshold, and the determining in this Action 712, 609 may be based on whether or not the predicted quality of the communication between the wireless device 130 and the second cell 124 exceeds the another threshold.

The determining in this Action 712, 609 of whether to proceed with the change from the first cell 123 to the second cell 124, or to suspend the change, may be based on whether or not the determined count exceeds the first threshold.

### Action 713

In some embodiments, the method comprises, in this Action 713, which corresponds to Action 610, sending, by the first node 111, based on the result of the determination, the indication to the second node 112 operating in the communications system 100. The second node 112 serves the wireless device 130 in the primary cell group 121. The indication indicates to proceed with the change, wherein: i) with the proviso that the result is to proceed with the change, the first node 111 sends the indication, in this Action 713, 610, and ii) with the proviso that the result is to suspend the change, the first node 111 refrains from sending the indication and suspends the change.

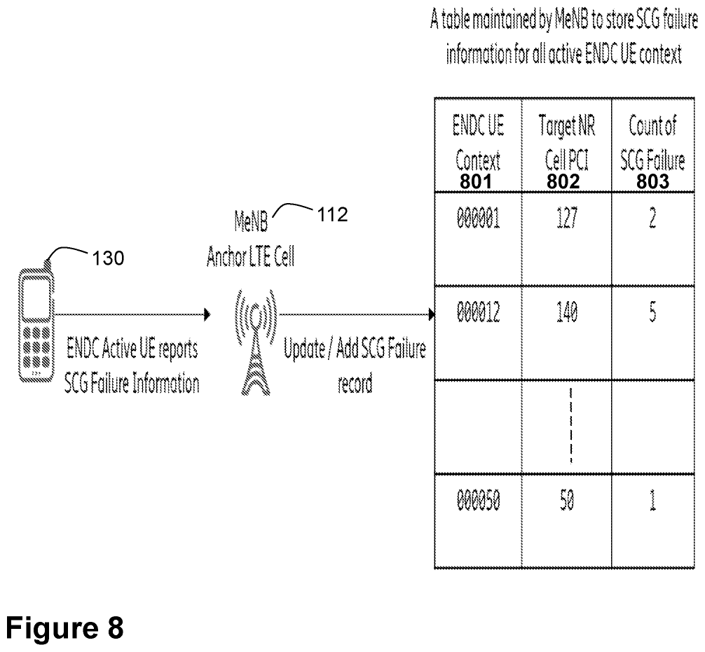

FIG. 8 is a schematic diagram illustrating how the second node 112, an MeNB, managing an anchor LTE cell in the primary cell group 121, receives reports comprising SCG failure information from the wireless device 130. The second node 112 then modifies a table it maintains to store SCG failure information for the UE context of all active EN-DC devices, by one of adding an SCG record, or updating an SCG record, according to the received reports. As depicted in the Figure, the table may comprise an identifier for the EN-DC UE context 801, an identifier for the target cell 802, e.g., for the second cell 124, and a count for the SCG failures 803.

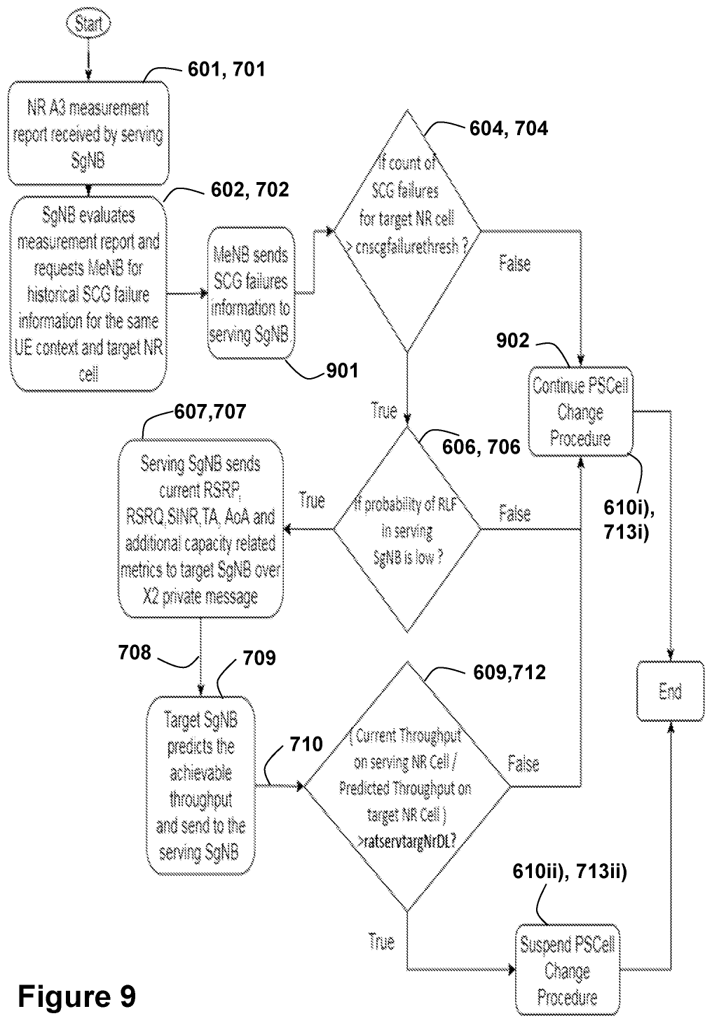

FIG. 9 is a flowchart illustrating a non-limiting example of a method in the communications system 100, according to embodiments herein, wherein the first node 111 is a serving SgNB, the first cell 123 is a serving NR cell, the second node 112 is an MeNB, the third node 113 is a target SgNB, and the second cell 124 is a target NR cell. The first node 111, in accordance with Actions 601 and 701, receives the NR A3 measurement report from the wireless device 130 and evaluates the measurement report. Next, according to Actions 602 and 702, evaluates the measurement report and requests the second node 112 for the historical SCG failure information for the same UE context and target NR cell. MeNB stores information of all previous SCG failures which happened either during PSCell Change or EN-DC setup for each active ENDC UE context and NR PCI. The second node 112, at 901, shares this information with the serving SgNB on its request over a X2 private message. After evaluating the SCG failures information for the target NR cell, the serving SgNB, in accordance with Actions 604, 704, checks if the count of SCG failures for the target NR cell exceeds the first threshold, the cnscgfailurethresh. If the result is that this is false, the first node 111 continues with the PSCell Change procedure at 902. If the result is that this is true, the first node 111 checks for other conditions such as probability of RLF on the serving NR cell with the current radio conditions is low, in accordance with Actions 606, 706. The probability of RLF in the serving NR cell may be predicted using a K-NN classification ML model. If the result is that this is false, the first node 111 continues with the PSCell Change procedure at 902. If the result is that this is true, the first node 111, in accordance with Actions 607, 707, sends the second message with the current RSRP, RSRQ, SINR, TA, AoA, and additional capacity related metrics to the target SgNB, as an X2 private message. The third node 113, in accordance with Action 708, receives the second message, and, in accordance with Action 709, predicts the achievable throughput. A Random Forest regression ML model may be used for predicting the DL throughput in the target NR cell. The third node 113 then sends, in agreement with Action 710, the predicted DL quality in the target NR cell to the first node 111. In accordance with Actions 609, 712, the first node 111 then determines if the ratio of estimated NR DL throughput in the serving NR cell with the achievable, that is, predicted, DL throughput in the target NR cell exceeds the another threshold, that is, the ratservtargNrDL. If the result is that this is false, the first node 111 continues with the PSCell Change procedure at 902. If the result is that this is true, the first node 111, in accordance with Actions 610ii), 713ii), suspends the PSCell Procedure. Based on the assessment of the above outcomes, the serving SgNB may either proceed with or refrain from sending either the SgNB change required message to the MeNB, in case of an inter gNodeB PSCell change, or the SgNB modification required message, in case of an intra gNodeB PSCell change, in response to the UE reported NR A3 measurement report.

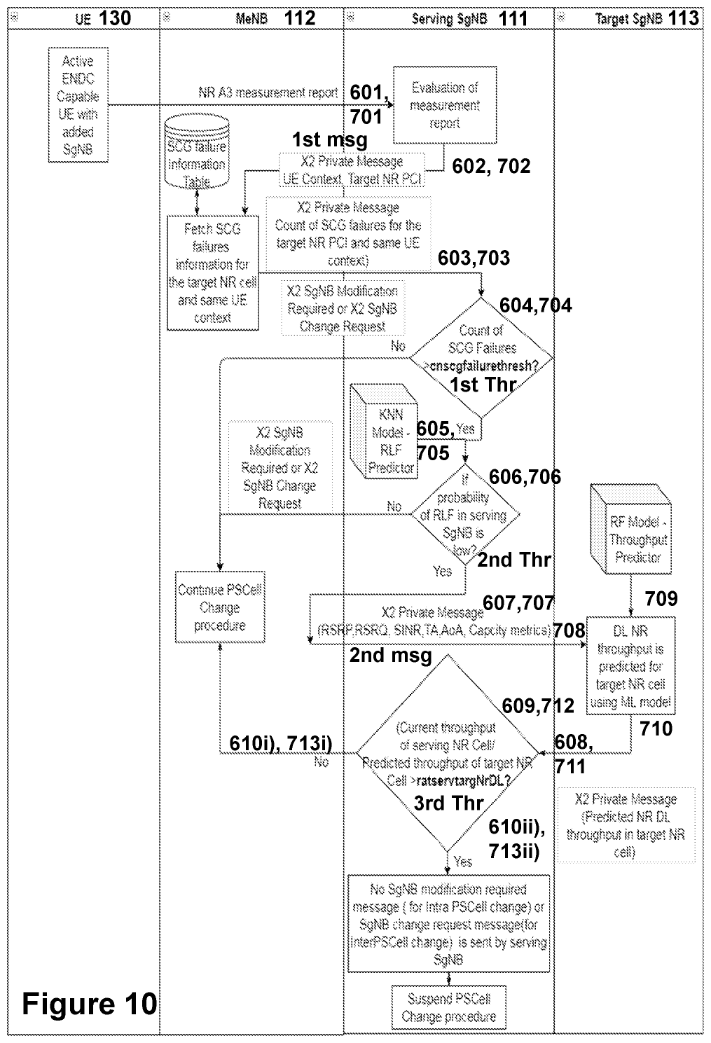

FIG. 10 is another flowchart illustrating a different view of the non-limiting example of the method in the communications system 100 just described in FIG. 9. FIG. 9 depicts the different actors of the different actions, as well as the messages that may be exchanged between the nodes involved, and the ML models that may be used by the first node 111 and the second node 112, respectively, to perform some of the methods actions. The numbering in the figure corresponds to that described in relation to FIG. 6 and/or FIG. 7 and will therefore not be repeated here.

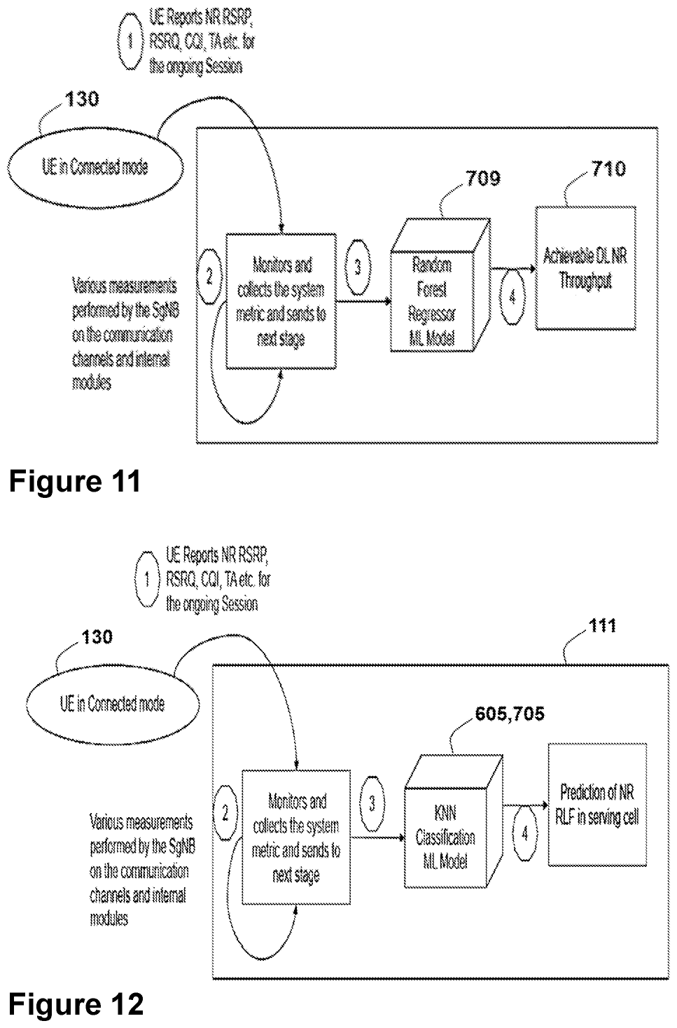

FIG. 11 is a schematic diagram illustrating how the third node 113 may determine the predicted DL NR throughput in the second cell 124 using a regressor Random Forest regressor ML model. At 1, the wireless device 130, a UE in Connected mode, may provide various measurements to the first node 111, which may then be provided to the third node 113 using the second message. At 2, the first node 111 also monitors and collects various measurements performed by the first node 111 on the communication channels and internal modules. The third node 113 collects the system metrics and at 3, it feeds them to the Random Forest Regressor ML model, to determine the predicted DL NR throughput in the second cell 124 in accordance with Action 709. At 4, the third node 113 outputs the predicted DL NR throughput in the second cell 124, in accordance with Action 710.

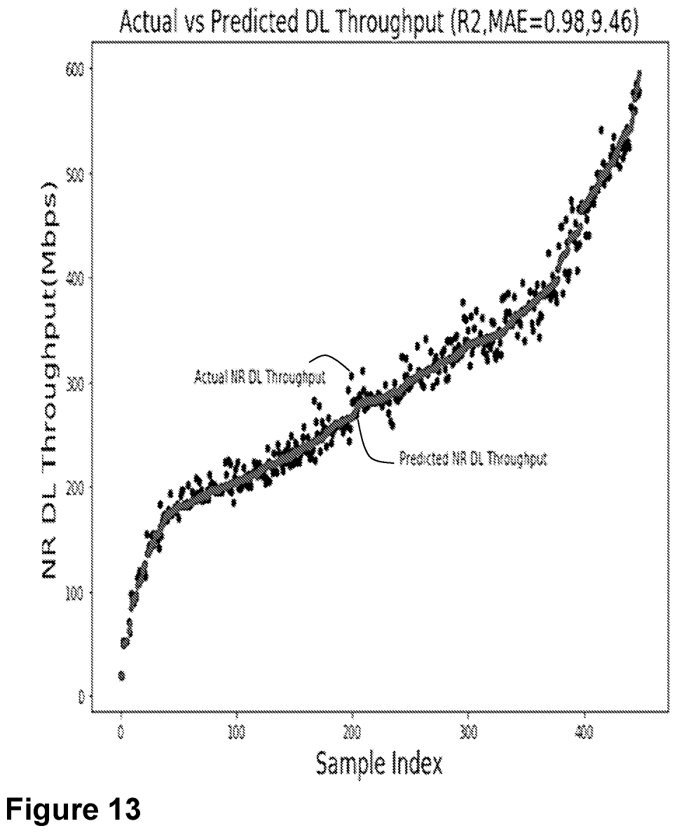

FIG. 12 is a schematic diagram illustrating how the first node 111 may determine the probability of RLF for the wireless device 130 at the first cell 123 using a KNN classification ML model. At 1, the wireless device 130, a UE in Connected mode, may provide various measurements to the first node 111. At 2, the first node 111 also monitors and collects various measurements performed by the first node 111 on the communication channels and internal modules. The third node 113 collects the system metrics and at 3, it feeds them to the KNN classification ML model, to determine the probability of RLF for the wireless device 130 at the first cell 123 with Actions 605 and 705. At 4, the first node 111 outputs the probability of RLF for the wireless device 130 at the first cell 123.

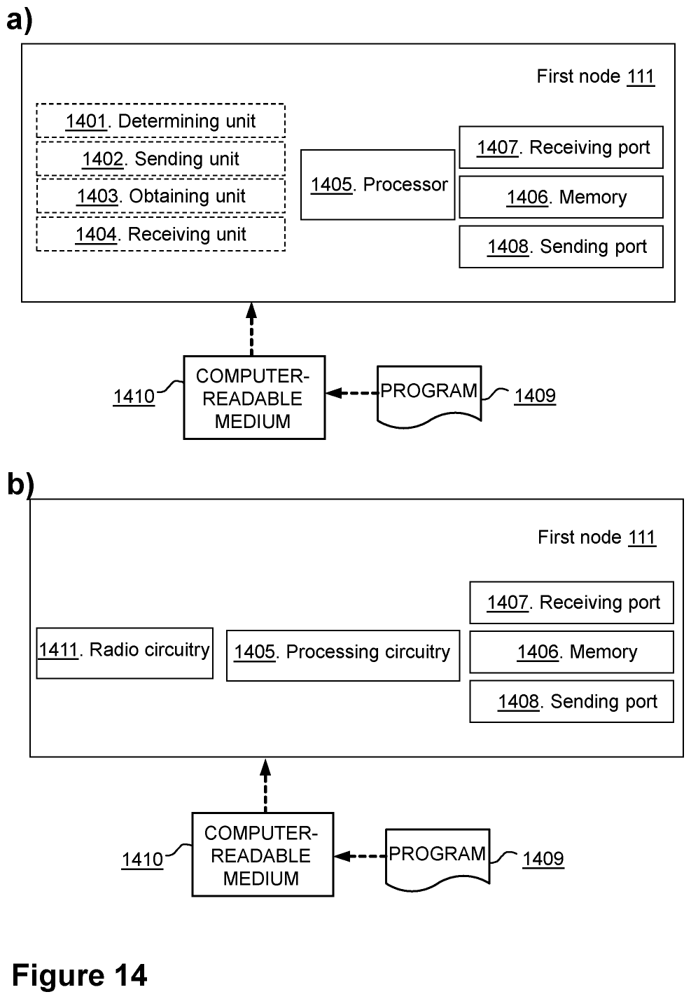

FIG. 13 is a graphic representation illustrating the accuracy of a non-limiting example of the second model as a Random Forest model. The graph plots the observed, or actual, NR DL throughput in Megabits per second (Mbps) in a target cell, and the NR DL throughput predicted by the second model for the same cell in the Y axis, for each of the test sample indices represented in the horizontal axis. The resulting second model has a coefficient of regression of R2=0.98 and a Mean Absolute Error (MAE)=9.46. For example, for a test sample with index i, the actual DL throughput value is xi. Then for the same sample index i, the predicted throughput is yi. Then Mean Absolute Error (MAE) may be calculated as:

$$MAE = \frac{{\sum }_{i = 1}^{n} \vert {y}_{i} - {x}_{i} \vert}{n}$$

where n is total number of test samples.

Certain embodiments disclosed herein may provide one or more of the following technical advantage(s), which may be summarized as follows. As a summarized overview of the above, embodiments herein may be understood to enable to mitigate the problems discussed in the Background section in relation to the existing methods, by checking historical information on SCG failures in the second cell 124, e.g., a target NR cell, reported in the NR A3 measurement report, before the first node 111 or the second node 112, a serving MeNB, may initiate a PSCell change procedure to the same target NR cell. This may be understood to enable to improve the user perception by not allowing the wireless device 130 to perform the PSCell change to a target NR cell for which consecutive SCG failures may have been already been received by the second node 112 from the wireless device 130. This may be understood to improve the actual NR A3 handover success rate by avoiding a PSCell change towards a target cell observed with high handover and/or SCG addition failures. This may in turn be understood to help to improve the experience, e.g., 5G experience, of the user of the wireless device 130, while ensuring its time on NR is improved, which may be considered to be one of the most important indicators considered by network operators to determine 5G NR network performance. Embodiments herein may be understood to provide methods that enable to provide the wireless device 130 uninterrupted user plane by restricting handover towards an NR cell where the wireless device 130 may have reported high SCG failure historically. Moreover, the end-user experience may be improved in terms of throughput. Furthermore, there may be a reduction in latency and signaling load on the LTE side due to the reduced re-attempting of PSCell change towards a target NR Cell demonstrating high SCG Failure. In turn, this may result as well in an improved battery life for the wireless device 130 since, with this solution, an EN-DC capable UE may not need to measure an NR cell repeatedly.

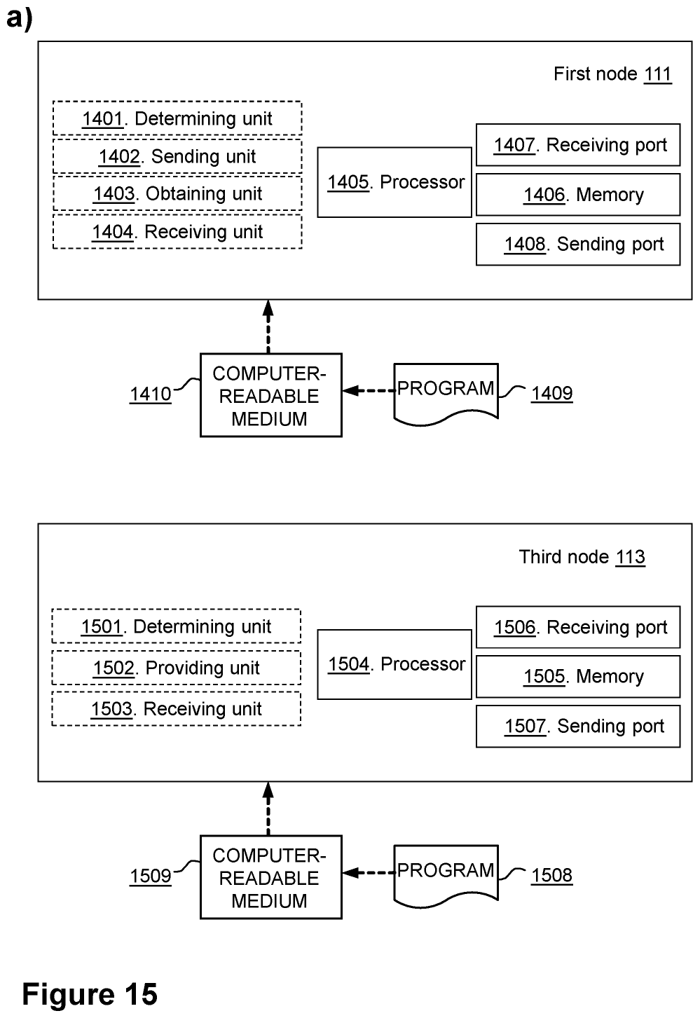

FIG. 14 depicts two different examples in panels a) and b), respectively, of the arrangement that the first node 111 may comprise to perform the method actions described above in relation to FIG. 6, FIGS. 9-10 and/or FIG. 12. In some embodiments, the first node 111 may comprise the following arrangement depicted in FIG. 14a. The first node 111 is configured to serve the wireless device 130 in the secondary cell group 122. The first node 111 may be understood to be for handling the change of the wireless device 130 from the first cell 123 to the second cell 124. The first node 111 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 14, optional boxes are indicated by dashed lines. The detailed description of some of the following corresponds to the same references provided above, in relation to the actions described for the first node 111 and will thus not be repeated here. For example, in some embodiments, the first node 111 may be the MeNB, the second node 112 may be the Serving SgNB and the third node 113 may be the target SgNB.

The first node 111 is configured to, e.g. by means of a determining unit 1401 within the first node 111 configured to, determine whether to proceed with the change from the first cell 123 to the second cell 124, or to suspend the change. The determining is configured to be performed with the proviso that the probability of RLF for the wireless device 130 at the first cell 123 is lower than the threshold. The determining is further configured to be based on whether or not the predicted quality of the communication between the wireless device 130 and the second cell 124 exceeds another threshold.

The first node 111 is also configured to, e.g. by means of a sending unit 1402 within the first node 111 configured to, send based on the result of the determination, the indication to the second node 112 configured to operate in the communications system 100. The second node 112 is configured to serve the wireless device 130 in the primary cell group 121. The indication is configured to indicate to proceed with the change, wherein: i) with the proviso that the result is to proceed with the change, the first node 111 is configured to send the indication, and ii) with the proviso that the result is to suspend the change, the first node 111 is configured to refrain from sending the indication and suspend the change.

In some embodiments, the first node 111 may be configured to, e.g. by means of an obtaining unit 1403 within the first node 111 configured to, obtain, from the second node 112, the count of consecutive secondary cell group failures at the second cell 124.

The first node 111 may be further configured to, e.g. by means of the determining unit 1401 further configured to, determine whether or not the count of consecutive secondary cell group failures at the second cell 124 exceeds the first threshold. The determining of whether to proceed with the change from the first cell 123 to the second cell 124, or to suspend the change, may be configured to be based on whether or not the count configured to be determined exceeds the first threshold.

The first node 111 may be further configured to, e.g. by means of a receiving unit 1404 further configured to, receive the measurement report from the wireless device 130 on the second cell 124.

The first node 111 may be further configured to, e.g. by means of the sending unit 1402 further configured to, send, based on the measurement report configured to be received, the first message to the second node 112. The first message may be configured to request the count of consecutive secondary cell group failures at the second cell 124.

In some embodiments, the measurement report may be configured to comprise at least one of: the NR A3 measurement report, the second indication of downlink coverage, the third indication of downlink signal-to-noise and interference ratio, and the fourth indication of the RSRQ.

In some embodiments, the count of consecutive secondary cell group failures at the second cell 124 may be configured to be monitored over the time period.

In some embodiments, the predicted quality of the communication between the wireless device 130 and the second cell 124 may be configured to be DL throughput, and the another threshold may be configured to be based on the ratio of the current DL throughput in the first cell 123 over the predicted DL throughput in the second cell 124.

In some embodiments, the first node 111 may be further configured to, e.g. by means of the determining unit 1401 further configured to, determine, using the classification ML model, the probability of RLF for the wireless device 130 at the first cell 123.

In some embodiments, the first node 111 may be further configured to, e.g. by means of the determining unit 1401 further configured to, determine whether the probability of RLF for the wireless device 130 at the first cell 123 configured to be determined falls within the first category of probabilities configured to be lower than the threshold. The threshold may be configured to be the second threshold.

In some embodiments, the first node 111 may be further configured to, e.g. by means of the sending unit 1402 further configured to, send, with the proviso that the probability of RLF for the wireless device 130 at the first cell 123 configured to be determined falls within the first category of probabilities configured to be lower than the second threshold, the second message to the third node 113. The third node 113 may be configured to manage the second cell 124. The second message may be configured to request the predicted DL throughput in the second cell 124.

In some embodiments, the first node 111 may be further configured to, e.g. by means of the obtaining unit 1403 further configured to, obtain, based on the second message configured to be sent, the predicted DL throughput in the second cell 124 from the third node 113.

The embodiments herein may be implemented through one or more processors, such as a processor 1405 in the first node 111 depicted in FIG. 14, together with computer program code for performing the functions and actions of the embodiments herein. The program code mentioned above may also be provided as a computer program product, for instance in the form of a data carrier carrying computer program code for performing the embodiments herein when being loaded into the in the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 1406 comprising one or more memory units. The memory 1406 is arranged to be used to store obtained information, store data, configurations, schedulings, and applications etc. to perform the methods herein when being executed in the first node 111.

In some embodiments, the first node 111 may receive information from, e.g., the second node 112, the third node 113, and/or the wireless device 130 through a receiving port 1407. In some examples, the receiving port 1407 may be, for example, connected to one or more antennas in the first node 111. In other embodiments, the first node 111 may receive information from another structure in the communications system 100 through the receiving port 1407. Since the receiving port 1407 may be in communication with the processor 1405, the receiving port 1407 may then send the received information to the processor 1405. The receiving port 1407 may also be configured to receive other information.

The processor 1405 in the first node 111 may be further configured to transmit or send information to e.g., the second node 112, the third node 113, the wireless device 130 and/or another structure in the communications system 100, through a sending port 1408, which may be in communication with the processor 1405, and the memory 1406.

Those skilled in the art will also appreciate that any of the units 1401-1404 described above may refer to a combination of analog and digital circuits, and/or one or more processors configured with software and/or firmware, e.g., stored in memory, that, when executed by the one or more processors such as the processor 1405, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1401-1404 described above may be the processor 1405 of the first node 111, or an application running on such processor.

Thus, the methods according to the embodiments described herein for the first node 111 may be respectively implemented by means of a computer program 1409 product, comprising instructions, i.e., software code portions, which, when executed on at least one processor 1405, cause the at least one processor 1405 to carry out the actions described herein, as performed by the first node 111. The computer program 1409 product may be stored on a computer-readable storage medium 1410. The computer-readable storage medium 1410, having stored thereon the computer program 1409, may comprise instructions which, when executed on at least one processor 1405, cause the at least one processor 1405 to carry out the actions described herein, as performed by the first node 111. In some embodiments, the computer-readable storage medium 1410 may be a non-transitory computer-readable storage medium, such as a CD ROM disc, a memory stick, or stored in the cloud space. In other embodiments, the computer program 1409 product may be stored on a carrier containing the computer program, wherein the carrier is one of an electronic signal, optical signal, radio signal, or the computer-readable storage medium 1410, as described above.

The first node 111 may comprise an interface unit to facilitate communications between the first node 111 and other nodes or devices, e.g., the second node 112, the third node 113, the wireless device 130 and/or another structure in the communications system 100. In some particular examples, the interface may, for example, include a transceiver configured to transmit and receive radio signals over an air interface in accordance with a suitable standard.

In other embodiments, the first node 111 may comprise the following arrangement depicted in FIG. 14b. The first node 111 may comprise a processing circuitry 1405, e.g., one or more processors such as the processor 1405, in the first node 111 and the memory 1406. The first node 111 may also comprise a radio circuitry 1411, which may comprise e.g., the receiving port 1407 and the sending port 1408. The processing circuitry 1405 may be configured to, or operable to, perform the method actions according to FIG. 6, FIGS. 9-10 and/or FIG. 12, in a similar manner as that described in relation to FIG. 14a. The radio circuitry 1411 may be configured to set up and maintain at least a wireless connection with the second node 112, the third node 113, the wireless device 130 and/or another structure in the communications system 100.

Hence, embodiments herein also relate to the first node 111 operative to handle a change of the wireless device 130 from the first cell 123 to the second cell 124, the first node 111 being operative to operate in the communications system 100. The first node 111 may comprise the processing circuitry 1405 and the memory 1406, said memory 1406 containing instructions executable by said processing circuitry 1405, whereby the first node 111 is further operative to perform the actions described herein in relation to the first node 111, e.g., in FIG. 6, FIGS. 9-10 and/or FIG. 12.

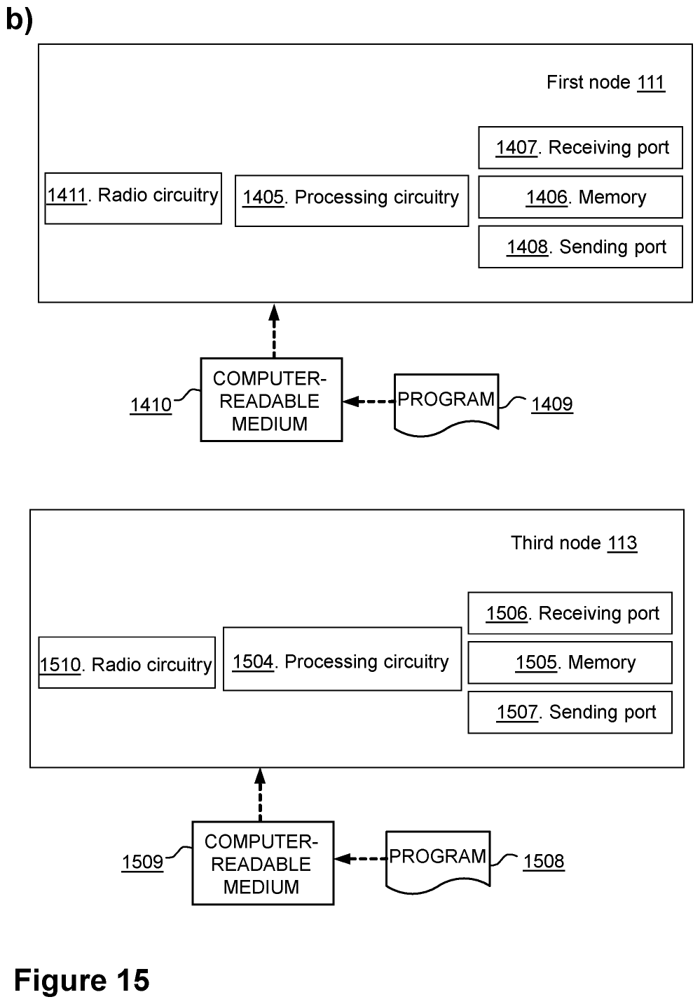

FIG. 15 depicts two different examples in panels a) and b), respectively, of the arrangement that the communications system 100 may comprise to perform the method actions described above in relation to FIG. 7 and/or FIGS. 8-10. In some embodiments, the communications system 100 may comprise the following arrangement depicted in FIG. 14a. The arrangement depicted in panel a) for the first node 111 corresponds to that described in relation to panel a) in FIG. 14 for the first node 111. The arrangement depicted in panel b) for the first node 111 corresponds to that described in relation to panel b) in FIG. 15 for the first node 111. The communications system 100 may be for handling the change of the wireless device 130 from the first cell 123 to the second cell 124. The communications system 100 comprises the first node 111, and the third node 113. The first node 111 is configured to serve the wireless device 130 in the secondary cell group 122.

Several embodiments are comprised herein. Components from one embodiment may be tacitly assumed to be present in another embodiment and it will be obvious to a person skilled in the art how those components may be used in the other exemplary embodiments. In FIG. 14, optional boxes are indicated by dashed lines. The detailed description of some of the following corresponds to the same references provided above, in relation to the actions described for the first node 111 and will thus not be repeated here. For example, in some embodiments, the first node 111 may be the MeNB, the second node 112 may be the Serving SgNB and the third node 113 may be the target SgNB.

The communications system 100 is configured to, e.g. by means of a determining unit 1501 within the third node 113 configured to, determine, by the third node 113, and using the second ML model, the predicted DL quality in the second cell 124.

The communications system 100 is also configured to, e.g. by means of a providing unit 1502 within the third node 113 configured to, provide, by the third node 113, the predicted DL quality in the second cell 124 to the first node 111.

The communications system 100 is configured to, e.g. by means of the determining unit 1401 within the first node 111 configured to, determine, by the first node 111, whether to proceed with the change from the first cell 123 to the second cell 124, or to suspend the change. The determining is configured to be performed with the proviso that the probability of RLF for the wireless device 130 at the first cell 123 is lower than the threshold. The determining is further configured to be based on whether or not the predicted quality of the communication configured between the wireless device 130 and the second cell 124 exceeds another threshold.

The communications system 100 is also configured to, e.g. by means of the sending unit 1402 within the first node 111 configured to, send, by the first node 111, based on the result of the determination, the indication to the second node 112 configured to operate in the communications system 100. The second node 112 is configured to serve the wireless device 130 in the primary cell group 121. The indication is configured to indicate to proceed with the change, wherein: i) with the proviso that the result is to proceed with the change, the first node 111 is configured to send the indication, and ii) with the proviso that the result is to suspend the change, the first node 111 is configured to refrain from sending the indication and suspend the change.

In some embodiments, the communications system 100 may be configured to, e.g. by means of the obtaining unit 1403 within the first node 111 configured to, obtain, by the first node 111, from the second node 112, the count of consecutive secondary cell group failures at the second cell 124.

The communications system 100 may be further configured to, e.g. by means of the determining unit 1401 further configured to, determine, by the first node 111, whether or not the count of consecutive secondary cell group failures at the second cell 124 exceeds the first threshold. The determining of whether to proceed with the change from the first cell 123 to the second cell 124, or to suspend the change, may be configured to be based on whether or not the count configured to be determined exceeds the first threshold.

The communications system 100 may be further configured to, e.g. by means of the receiving unit 1404 further configured to, receive, by the first node 111, the measurement report from the wireless device 130 on the second cell 124.

The communications system 100 may be further configured to, e.g. by means of the sending unit 1402 further configured to, send, by the first node 111, based on the measurement report configured to be received, the first message to the second node 112.

The first message may be configured to request the count of consecutive secondary cell group failures at the second cell 124.

In some embodiments, the measurement report may be configured to comprise at least one of: the NR A3 measurement report, the second indication of DL coverage, the third indication of DL signal-to-noise and interference ratio, and the fourth indication of the RSRQ.

In some embodiments, the count of consecutive secondary cell group failures at the second cell 124 may be configured to be monitored over the time period.

In some embodiments, the predicted quality of the communication between the wireless device 130 and the second cell 124 may be configured to be DL throughput, and the another threshold may be configured to be based on the ratio of the current DL throughput in the first cell 123 over the predicted DL throughput in the second cell 124.

In some embodiments, the communications system 100 may be further configured to, e.g. by means of the determining unit 1401 further configured to, determine, by the first node 111, using the classification ML model, the probability of RLF for the wireless device 130 at the first cell 123.

In some embodiments, the communications system 100 may be further configured to, e.g. by means of the determining unit 1401 further configured to, determine, by the first node 111, whether the probability of RLF for the wireless device 130 at the first cell 123 configured to be determined falls within the first category of probabilities configured to be lower than the threshold. The threshold may be configured to be the second threshold.

In some embodiments, the communications system 100 may be further configured to, e.g. by means of the sending unit 1402 further configured to, send, by the first node 111, with the proviso that the probability of RLF for the wireless device 130 at the first cell 123 configured to be determined falls within the first category of probabilities configured to be lower than the second threshold, the second message to the third node 113. The third node 113 may be configured to manage the second cell 124. The second message may be configured to request the predicted DL throughput in the second cell 124.

The communications system 100 is also configured to, e.g. by means of a receiving unit 1503 within the third node 113 configured to, receive, by the third node 113, the second message. The determining of the predicted DL throughput in the second cell 124 may be configured to be triggered by the second message configured to be received.

In some embodiments, the communications system 100 may be further configured to, e.g. by means of the obtaining unit 1403 further configured to, obtain, by the first node 111, based on the second message configured to be sent, the predicted DL throughput in the second cell 124 from the third node 113.

In some embodiments, the second ML model may be configured to be a regressor model.

The remaining configurations described for the first node 111 in relation to FIG. 14, may be understood to correspond to those described in FIG. 14, respectively, and to be performed, e.g., by means of the corresponding units and arrangements described in FIG. 14, which will not be repeated here.

The embodiments herein may be implemented through one or more processors, such as a processor 1504 in the third node 113 depicted in FIG. 15, together with computer program code for performing the functions and actions of the embodiments herein. The program code mentioned above may also be provided as a computer program product, for instance in the form of a data carrier carrying computer program code for performing the embodiments herein when being loaded into the in the third node 113. One such carrier may be in the form of a CD ROM disc. It is however feasible with other data carriers such as a memory stick. The computer program code may furthermore be provided as pure program code on a server and downloaded to the third node 113.

The third node 113 may further comprise a memory 1505 comprising one or more memory units. The memory 1505 is arranged to be used to store obtained information, store data, configurations, schedulings, and applications etc. to perform the methods herein when being executed in the third node 113.

In some embodiments, the third node 113 may receive information from, e.g., the first node 111, the second node 112, and/or the wireless device 130 through a receiving port 1506. In some examples, the receiving port 1506 may be, for example, connected to one or more antennas in the third node 113. In other embodiments, the third node 113 may receive information from another structure in the communications system 100 through the receiving port 1506. Since the receiving port 1506 may be in communication with the processor 1504, the receiving port 1506 may then send the received information to the processor 1504. The receiving port 1506 may also be configured to receive other information.

The processor 1504 in the third node 113 may be further configured to transmit or send information to e.g., the first node 111, the second node 112, the wireless device 130 and/or another structure in the communications system 100, through a sending port 1507, which may be in communication with the processor 1504, and the memory 1505.

Those skilled in the art will also appreciate that any of the units 1501-1503 described above may refer to a combination of analog and digital circuits, and/or one or more processors configured with software and/or firmware, e.g., stored in memory, that, when executed by the one or more processors such as the processor 1504, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1501-1503 described above may be the processor 1504 of the third node 113, or an application running on such processor.

Thus, the methods according to the embodiments described herein for the third node 113 may be respectively implemented by means of a computer program 1508 product, comprising instructions, i.e., software code portions, which, when executed on at least one processor 1504, cause the at least one processor 1504 to carry out the actions described herein, as performed by the third node 113. The computer program 1508 product may be stored on a computer-readable storage medium 1509. The computer-readable storage medium 1509, having stored thereon the computer program 1508, may comprise instructions which, when executed on at least one processor 1504, cause the at least one processor 1504 to carry out the actions described herein, as performed by the third node 113. In some embodiments, the computer-readable storage medium 1509 may be a non-transitory computer-readable storage medium, such as a CD ROM disc, a memory stick, or stored in the cloud space. In other embodiments, the computer program 1508 product may be stored on a carrier containing the computer program, wherein the carrier is one of an electronic signal, optical signal, radio signal, or the computer-readable storage medium 1509, as described above.

The third node 113 may comprise an interface unit to facilitate communications between the third node 113 and other nodes or devices, e.g., the first node 111, the second node 112, the wireless device 130 and/or another structure in the communications system 100. In some particular examples, the interface may, for example, include a transceiver configured to transmit and receive radio signals over an air interface in accordance with a suitable standard.

In other embodiments, the third node 113 may comprise the following arrangement depicted in FIG. 15b. The third node 113 may comprise a processing circuitry 1504, e.g., one or more processors such as the processor 1504, in the third node 113 and the memory 1505. The third node 113 may also comprise a radio circuitry 1510, which may comprise e.g., the receiving port 1506 and the sending port 1507. The processing circuitry 1504 may be configured to, or operable to, perform the method actions according to FIG. 7, FIGS. 9-11 and/or FIG. 13, in a similar manner as that described in relation to FIG. 14a. The radio circuitry 1510 may be configured to set up and maintain at least a wireless connection with the first node 111, the second node 112, the wireless device 130 and/or another structure in the communications system 100.

Hence, embodiments herein also relate to the third node 113 operative to handle a change of the wireless device 130 from the first cell 123 to the second cell 124, the third node 113 being operative to operate in the communications system 100. The third node 113 may comprise the processing circuitry 1504 and the memory 1505, said memory 1505 containing instructions executable by said processing circuitry 1504, whereby the third node 113 is further operative to perform the actions described herein in relation to the third node 113, e.g., in FIG. 7, FIGS. 9-11 and/or FIG. 13.

When using the word “comprise” or “comprising”, it shall be interpreted as non-limiting, i.e. meaning “consist at least of”.

The embodiments herein are not limited to the above described preferred embodiments.

Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

1-36. (canceled)

37. A computer-implemented method, performed by a first node, the first node serving a wireless device in a secondary cell group, the method being for handling a change of the wireless device from a first cell to a second cell, the first node operating in a communications system, the method comprising:
determining whether to proceed with the change from the first cell to the second cell, or to suspend the change, the determining being performed with the proviso that a probability of radio link failure for the wireless device at the first cell is lower than a threshold, and the determining being based on whether or not a predicted quality of a communication between the wireless device and the second cell exceeds another threshold; and
sending, based on a result of the determination, an indication to a second node operating in the communications system, the second node serving the wireless device in a primary cell group, and the indication indicating to proceed with the change, wherein:
with the proviso that the result is to proceed with the change, the first node sends the indication, and
with the proviso that the result is to suspend the change, the first node refrains from sending the indication and suspends the change.

38. The method according to claim 37, further comprising:
obtaining, from the second node, a count of consecutive secondary cell group failures at the second cell; and
determining whether or not the count of consecutive secondary cell group failures at the second cell exceeds a first threshold, wherein the determining of whether to proceed with the change from the first cell to the second cell, or to suspend the change, is based on whether or not the determined count exceeds the first threshold.

39. The method according to claim 38, further comprising:
receiving a measurement report from the wireless device on the second cell; and,
sending, based on the received measurement report, a first message to the second node, the first message requesting the count of consecutive secondary cell group failures at the second cell.

40. The method according to claim 39, wherein the measurement report comprises at least one of: an NR A3 measurement report, a second indication of downlink coverage, a third indication of downlink signal-to-noise and interference ratio, and a fourth indication of a Reference Signal Received Quality.

41. The method according to claim 38, wherein the count of consecutive secondary cell group failures at the second cell is monitored over a time period.

42. The method according to claim 37, wherein the predicted quality of the communication between the wireless device and the second cell is Downlink (DL) throughput, and wherein the other threshold is based on a ratio of a current DL throughput in the first cell over a predicted DL throughput in the second cell.

43. The method according to claim 42, wherein the method further comprises,
sending, with the proviso that the determined probability of radio link failure for the wireless device at the first cell falls within the first category of probabilities being lower than the second threshold, a second message to a third node managing the second cell, the second message requesting the predicted DL throughput in the second cell, and
obtaining, based on the sent second message, the predicted DL throughput in the second cell from the third node.

44. The method according to claim 37, further comprising:
determining, using a classification machine-learning model, the probability of radio link failure for the wireless device at the first cell; and
determining whether the determined probability of radio link failure for the wireless device at the first cell falls within a first category of probabilities being lower than the threshold, the threshold being a second threshold.

45. A computer-implemented method, performed by a communications system, the method being for handling a change of a wireless device from a first cell to a second cell, the communications system comprising a first node, and a third node, the first node serving a wireless device in a secondary cell group, the method comprising:
determining, by the third node, and using a second machine-learning model, a predicted downlink (DL) quality in the second cell;
providing, by the third node, the predicted DL quality in the second cell to the first node;
determining, by the first node, whether to proceed with the change from the first cell to the second cell, or to suspend the change, the determining being performed with the proviso that a probability of radio link failure for the wireless device at the first cell is lower than a threshold, and the determining being based on whether or not the predicted quality of a communication between the wireless device and the second cell exceeds another threshold; and
sending, by the first node, based on a result of the determination, an indication to a second node operating in the communications system, the second node serving the wireless device in a primary cell group, and the indication indicating to proceed with the change, wherein:
with the proviso that the result is to proceed with the change, the first node sends the indication, and
with the proviso that the result is to suspend the change, the first node refrains from sending the indication and suspends the change.

46. The method according to claim 45, further comprising:
obtaining, by the first node, from the second node, a count of consecutive secondary cell group failures at the second cell; and
determining, by the first node, whether or not the count of consecutive secondary cell group failures at the second cell exceeds a first threshold, wherein the determining of whether to proceed with the change from the first cell to the second cell, or to suspend the change, is based on whether or not the determined count exceeds the first threshold.

47. The method according to claim 46, further comprising:
receiving, by the first node, a measurement report from the wireless device on the second cell; and,
sending, by the first node, based on the received measurement report, a first message to the second node, the first message requesting the count at the second cell.

48. The method according to claim 47, wherein the measurement report comprises at least one of: an NR A3 measurement report, a second indication of downlink coverage, a third indication of downlink signal-to-noise and interference ratio, and a fourth indication of a Reference Signal Received Quality.

49. The method according to claim 46, wherein the count of consecutive secondary cell group failures at the second cell is monitored over a time period.

50. The method according to claim 45, wherein the predicted quality of the communication between the wireless device and the second cell is downlink (DL) throughput, and wherein the other threshold is based on a ratio of a current DL throughput in the first cell over a predicted DL throughput in the second cell.

51. The method according to claim 45, further comprising:
determining, by the first node, using a classification machine-learning model, the probability of radio link failure for the wireless device at the first cell, and
determining, by the first node, whether the determined probability of radio link failure for the wireless device at the first cell falls within a first category of probabilities being lower than the threshold, the threshold being a second threshold.

52. The method according to claim 51, wherein the method further comprises:
sending, by the first node, with the proviso that the determined probability of radio link failure for the wireless device at the first cell falls within the first category of probabilities being lower than the second threshold, a second message to a third node managing the second cell, the second message requesting the predicted DL throughput in the second cell;
receiving, by the third node, the second message, wherein the determining, of the predicted DL throughput in the second cell is triggered by the received second message; and
obtaining, by the first node, based on the sent second message, the predicted DL throughput in the second cell from the third node.

53. The method according to claim 45, wherein the second machine-learning model is a regressor model.

54. A first node, configured to serve a wireless device in a secondary cell group, the first node being for handling a change of the wireless device from a first cell to a second cell, the first node being configured to operate in a communications system, the first node being further configured to:
determine whether to proceed with the change from the first cell to the second cell, or to suspend the change, the determining being configured to be performed with the proviso that a probability of radio link failure for the wireless device at the first cell is lower than a threshold, and the determining being further configured to be based on whether or not a predicted quality of a communication between the wireless device and the second cell exceeds another threshold, and
send, based on a result of the determination, an indication to a second node configured to operate in the communications system, the second node being configured to serve the wireless device in a primary cell group, and the indication being configured to indicate to proceed with the change, wherein:
with the proviso that the result is to proceed with the change, the first node is configured to send the indication, and
with the proviso that the result is to suspend the change, the first node is configured to refrain from sending the indication and suspend the change.

55. The first node according to claim 54, being further configured to:
obtain, from the second node, a count of consecutive secondary cell group failures at the second cell; and
determine whether or not the count of consecutive secondary cell group failures at the second cell exceeds a first threshold, wherein the determining of whether to proceed with the change from the first cell to the second cell, or to suspend the change, is configured to be based on whether or not the count configured to be determined exceeds the first threshold.

56. A communications system, for handling a change of a wireless device from a first cell to a second cell, the communications system comprising a first node, and a third node, the first node being configured to serve a wireless device in a secondary cell group, the communications system being configured to:
determine, by the third node, and using a second machine-learning model, a predicted DL quality in the second cell;
provide, by the third node, the predicted DL quality in the second cell to the first node;
determine, by the first node, whether to proceed with the change from the first cell to the second cell, or to suspend the change, the determining being configured to be performed with the proviso that a probability of radio link failure for the wireless device at the first cell is lower than a threshold, and the determining being configured to be based on whether or not the predicted quality of a communication between the wireless device and the second cell exceeds another threshold; and
send, by the first node, based on a result of the determination, an indication to a second node configured to operate in the communications system, the second node being configured to serve the wireless device in a primary cell group, and the indication being configured to indicate to proceed with the change, wherein:
with the proviso that the result is to proceed with the change, the first node is configured to send the indication, and
with the proviso that the result is to suspend the change, the first node is configured to refrain from sending the indication and suspend the change.
